(19) United States
(12) Patent Application Publication
(10) Pub. No.: US 2026/0082400 A1
(43) Pub. Date: Mar. 19, 2026

(54) CONNECTED MODE DISCONTINUOUS RECEPTION FOR UNICAST BIDIRECTIONAL TRAFFIC

(71) Applicant: QUALCOMM Incorporated, San Diego, CA (US)

(72) Inventors: Siyi Chen, Beijing (CN); Jing Sun, San Diego, CA (US); Xiaoxia Zhang, San Diego, CA (US); Chih-Hao Liu, San Diego, CA (US); Changlong Xu, Beijing (CN); Giovanni Chisci, San Diego, CA (US); Shaozhen Guo, Beijing (CN); Luanxia Yang, Beijing (CN); Hao Xu, Beijing (CN)

(21) Appl. No.: 19/110,730

(22) PCT Filed: Nov. 29, 2022
(86) PCT No.: PCT/CN2022/134934

§ 371 Date: Mar. 11, 2025

(51) Int. Cl. H04W 72/25; H04W 76/28

(52) U.S. Cl. CPC H04W 72/25; H04W 76/28

(57) ABSTRACT

Aspects of the disclosure relate to sidelink (SL) discontinuous reception (DRX) techniques. A first device may determine SL DRX configuration parameters for SL communication between the first device and a second device. The SL DRX configuration parameters include a plurality of first transmission durations and a plurality of first DRX on-durations, the plurality of first transmission durations include times during which the first device is permitted to transmit via SL communication to the second device and the plurality of first DRX on-durations include times during which the first device monitors for SL communication from the second device. The first device may, at least one of, monitor for SL communication from the second device during at least one of the plurality of first transmission durations, or transmit via SL communication to the second device during at least one of the plurality of first DRX on-durations.

### INTRODUCTION

The technology discussed below relates generally to wireless communication systems, and more particularly, to device-to-device (D2D) or sidelink (SL) communications.

As the demand for mobile broadband access continues to increase, research and development continue to advance wireless communication technologies not only to meet the growing demand for mobile broadband access, but to advance and enhance the user experience with mobile communications.

### SUMMARY

The following presents a simplified summary of one or more aspects of the present disclosure, to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Connected mode discontinuous reception (C-DRX) was recently introduced into 3GPP specifications for 5G NR, to reduce power consumption by allowing user equipment (UE), such as smartphones, other smart devices, laptop computers, IoT devices, or the like, to periodically enter into a sleep state or a power-saving mode, where the UE turns off (e.g., powers off) one or more major circuits when there is no intimation of a packet arrival.

In the C-DRX mode, the UE wakes up from the sleep state or the power-saving mode periodically to check for packet arrival. In order to prevent any loss of data, the UE and the network should have a predefined agreement about the UE's periodic transition between the sleep and wakeup states. Typically, the UE receives information regarding the periodic transition by way of discontinuous reception (DRX) configuration parameters in a downlink (DL) radio resource control (RRC) configuration message sent by the network (e.g., a gNode B (gNB) node) to the UE.

Sidelink (SL) communications permit UEs to communicate D2D without communicating through other communications network devices, such as a gNB node, base station, or the like. SL communications includes SL DRX for unicast, groupcast, and broadcast. During SL active time (e.g., when the UE is in the wakeup state), a UE may perform SL control indicator (SCI) monitoring for data reception (e.g., physical SL control channel (PSCCH) and second stage SCI on PSSCH). The UE may skip monitoring of SCI for data reception during SL DRX inactive time (e.g., when the UE is in the sleep state), as the UE may not receive data during SL DRX inactive time.

SL DRX configuration parameters may configure the SL active time into two groups: a plurality of transmission durations and a plurality of DRX on-durations. During a transmission duration, a UE is free to transmit to another UE which may be in a DRX on-duration. During a DRX on-duration, a UE may monitor SCI for transmissions from another UE. Traditionally, when using bi-directional SL DRX between two UEs, when one UE has a transmission duration, the other UE has a DRX on-duration, and vice-versa. In this manner, collisions between transmissions of the two UEs may be avoided. However, in some instances, it may be beneficial for the UE to transmit during its DRX on-duration or to receive during its transmission duration, for example a volume of traffic or priority of traffic may make it desirable to “extend” a DRX on-duration into a transmission duration or vice-versa.

As such, this disclosure sets forth techniques for facilitating transmission of a UE during its DRX on-duration(s) and/or monitoring SCI for data reception during its SL DRX transmission duration (e.g., extending a DRX on-duration into a transmission duration and/or extending a transmission duration into a DRX on-duration). This disclosure also describes various techniques for avoiding collisions. As such, the techniques of this disclosure present technological improvement(s) which may facilitate the transmission of more data and/or higher priority data with lower latency than with traditional SL DRX solutions, while still maintaining the power savings of the traditional SL DRX solutions.

In one example, a method of wireless communication at a first UE includes: determining sidelink (SL) discontinuous reception (DRX) configuration parameters for SL communication between the first UE and a second UE, the SL DRX configuration parameters comprising a plurality of first transmission durations and a plurality of first DRX on-durations, the plurality of first transmission durations comprising times during which the first UE is permitted to transmit via SL communication to the second UE and the plurality of first DRX on-durations comprising times during which the first UE monitors for SL communication from the second UE; and at least one of monitoring for SL communication from the second UE during at least one of the plurality of first transmission durations, or transmitting via SL communication to the second UE during at least one of the plurality of first DRX on-durations.

In another example, a method of wireless communication at a second UE, includes: determining sidelink (SL) discontinuous reception (DRX) configuration parameters for SL communication between a first UE and the second UE, the SL DRX configuration parameters comprising a plurality of first transmission durations and a plurality of first DRX on-durations, the plurality of first transmission durations comprising times during which the first UE is permitted to transmit via SL communication to the second UE and the plurality of first DRX on-durations comprising times during which the first UE monitors for SL communication from the second UE; and at least one of monitoring for SL communication from the first UE during at least one of the plurality of first DRX on-durations, or transmitting via SL communication to the first UE during at least one of the plurality of first transmission durations.

In another example, a device for wireless communication by a first user equipment (UE), includes: memory having executable instructions stored thereon; and one or more processors configured to execute the executable instructions to cause the apparatus to: determine sidelink (SL) discontinuous reception (DRX) configuration parameters for SL communication between the first UE and a second UE, the SL DRX configuration parameters comprising a plurality of first transmission durations and a plurality of first DRX on-durations, the plurality of first transmission durations comprising times during which the first UE is permitted to transmit via SL communication to the second UE and the plurality of first DRX on-durations comprising times during which the first UE monitors for SL communication from the second UE; and at least one of monitor for SL communication from the second UE during at least one of the plurality of first transmission durations, or transmit via SL communication to the second UE during at least one of the plurality of first DRX on-durations. a second device configured for wireless communication is disclosed.

In yet another example, a device for wireless communication by a second UE, includes memory having executable instructions stored thereon; and one or more processors configured to execute the executable instructions to cause the apparatus to: determine sidelink (SL) discontinuous reception (DRX) configuration parameters for SL communication between a first UE and the second UE, the SL DRX configuration parameters comprising a plurality of first transmission durations and a plurality of first DRX on-durations, the plurality of first transmission durations comprising times during which the first UE is permitted to transmit via SL communication to the second UE and the plurality of first DRX on-durations comprising times during which the first UE monitors for SL communication from the second UE; and at least one of monitor for SL communication from the first UE during at least one of the plurality of first DRX on-durations, or transmit via SL communication to the first UE during at least one of the plurality of first transmission durations.

These and other aspects of the technology discussed herein will become more fully understood upon a review of the detailed description, which follows. Other aspects and features will become apparent to those of ordinary skill in the art, upon reviewing the following description of specific examples in conjunction with the accompanying figures. While the following description may discuss various advantages and features relative to certain examples and figures, all examples can include one or more of the advantageous features discussed herein. In other words, while this description may discuss one or more examples as having certain advantageous features, one or more of such features may also be used in accordance with the various examples discussed herein. In similar fashion, while this description may discuss examples as device, system, or method examples, it should be understood that such exemplary examples can be implemented in various devices, systems, and methods.

### BRIEF DESCRIPTION OF THE DRAWINGS

FIG. 1 is a schematic diagram illustrating an example wireless communication system according to some aspects of this disclosure.

FIG. 2 is a conceptual diagram illustrating an example of a radio access network according to some aspects of this disclosure.

FIG. 3 is a schematic diagram illustrating an example distributed base station architecture according to some aspects of this disclosure.

FIG. 4 is a block diagram illustrating a radio protocol architecture for SL communication according to some aspects of this disclosure.

FIG. 5 is a timing diagram illustrating example DRX techniques according to some aspects of this disclosure.

FIG. 6 is a block diagram illustrating an example of a hardware implementation for a scheduling entity or gNB according to some aspects of this disclosure.

FIG. 7 is a block diagram illustrating an example of a hardware implementation for a scheduled entity or UE according to some aspects of this disclosure.

FIG. 8 is a conceptual diagram illustrating example SL communication techniques between two UEs according to some aspects of this disclosure.

FIG. 9 is a conceptual diagram illustrating example SL communication techniques for actively indicating to extend a DRX on-duration according to some aspects of this disclosure.

FIG. 10 is a conceptual diagram illustrating example SL communication techniques between two UEs including suggesting an extension of a DRX on-duration according to some aspects of this disclosure.

FIG. 11 is a conceptual diagram illustrating an example semi-static split of transmission and reception in a UE transmission duration according to some aspects of this disclosure.

FIG. 12 is a conceptual diagram illustrating an example of reservation of future transmission slots according to some aspects of this disclosure.

FIG. 13 is a conceptual diagram illustrating an example of the overriding of reserved slots to prioritize high priority traffic according to some aspects of this disclosure.

FIG. 14 is a conceptual diagram illustrating an example of the negotiating of reserved slots based on priority according to some aspects of this disclosure.

FIG. 15 is a flow diagram illustrating example SL DRX techniques according to one or more aspects of this disclosure.

FIG. 16 a flow diagram illustrating additional example SL DRX techniques according to one or more aspects of this disclosure.

### DETAILED DESCRIPTION

Aspects of the present disclosure relate to SL communications in a wireless communication system. For unicast communications between two UE, SL DRX may be configured per pair of source L2 ID (Layer 2 identifier) and destination L2 ID. Each of the two UEs may maintain a set of SL DRX timers for each direction per pair of source L2 ID and destination L2 ID. These SL DRX timers may be used to indicate, for example, transmission durations and/or DRX on-durations. The SL DRX configuration for a pair of source/destination L2 IDs for a direction may be negotiated between the UEs in the Access Stratum (AS) Layer (e.g., PHY (physical layer) and Layer 2).

In traditional SL DRX, when a PHY layer is indicated with an active time of a receiver (RX) UE from a medium access control (MAC) layer for candidate resource selection, a restriction is applied in the PHY layer so that at least a subset of candidate resources reported to the MAC layer is located within the indicated active time of the RX UE. If none of the candidate resources are within the receiver's active time, the UE implementation should add at least one resource that is within the active time.

In SL-unlicensed (SL-U), the UE performs listen before talk (LBT) before a transmission in order to avoid a collision with transmission(s) from another device(s) using the same resource(s). In other words, the UE may first determine that no other devices are transmitting via the resource(s) before starting to transmit. In some instances, a UE, after first selecting a set of resources, may fail LBT (e.g., another device(s) is transmitting over the same set of resources), which would trigger an LBT failure at the MAC layer. Two possible ways of handling such an LBT failure may include 1) an issue resource re-selection at the MAC layer; or 2) Use a re-transmission occasion for the initial transmission. Based on these conditions, if C-DRX is used in SL-U, the resource selected by the UE implementation may suffer from more interference than otherwise, increasing the probability of an LBT failure. Additionally, a frequent resource re-selection or insufficient resources may impede throughput.

The techniques of this disclosure may present improved balancing of resources between two UEs engaged in SL communications to facilitate transmission of higher priority and/or a higher volume of data while still maintaining power savings contemplated by traditional SL communications.

Various aspects of the present disclosure operate in an environment utilizing SL communications. The disclosure that follows presents various concepts that may be implemented across a broad variety of telecommunication systems, network architectures, and communication standards.

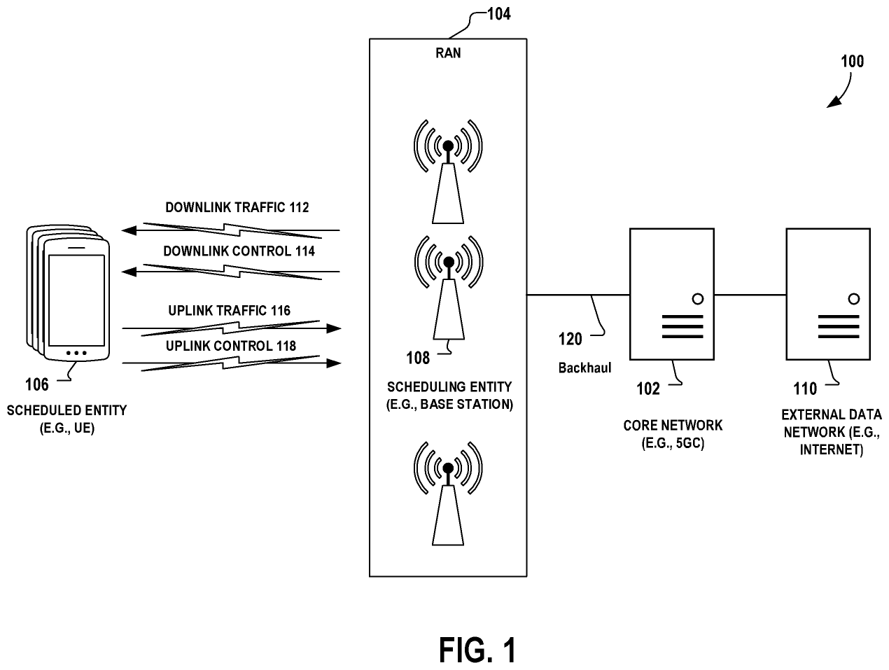

FIG. 1 is a schematic illustration of a wireless communication system according to some aspects of this disclosure. FIG. 1, as an illustrative example without limitation, shows various aspects of the present disclosure with reference to a wireless communication system 100. The wireless communication system 100 includes several interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G or 5G NR. In some examples, the RAN 104 may operate under a hybrid of 5G NR and Evolved Universal Terrestrial Radio Access Network (eUTRAN) standards, often referred to as Long Term Evolution (LTE). 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, those skilled in the art may variously refer to a “base station” as a BTS, a radio base station, a radio transceiver, a transceiver function, a BSS, an ESS, an AP, an NB, an eNB, a gNB, a 5G NB, a transmit receive point (TRP), or some other suitable terminology.

The RAN 104 supports wireless communication for multiple mobile apparatuses. Those skilled in the art may refer to a mobile apparatus as a UE, as in 3GPP specifications, but may also refer to a UE as a mobile station (MS), a subscriber station, a mobile unit, a subscriber unit, a wireless unit, a remote unit, a mobile device, a wireless device, a wireless communication device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides access to network services. A UE may take on many forms and can include a range of devices.

Within the present document, a “mobile” apparatus (aka a UE) need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, radio frequency (RF) chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; and agricultural equipment; etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant quality of service (QoS) for transport of critical service data. A mobile apparatus may additionally include two or more disaggregated devices in communication with one another, including, for example, a wearable device, a haptic sensor, a limb movement sensor, an eye movement sensor, etc., paired with a smartphone. In various examples, such disaggregated devices may communicate directly with one another over any suitable communication channel or interface, or may indirectly communicate with one another over a network (e.g., a local area network or LAN).

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In accordance with certain aspects of the present disclosure, the term downlink may refer to a point-to-multipoint transmission originating at a scheduling entity (described further below; e.g., network node 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled, wherein a scheduling entity (e.g., a network node 108) allocates resources for communication among some or all devices and equipment within its service area or cell. Within the present disclosure, as discussed further below, a scheduling entity may be responsible for scheduling, assigning, reconfiguring, and releasing resources for one or more scheduled entities. That is, for scheduled communication, UEs 106, which may be scheduled entities, may utilize resources allocated by a scheduling entity 108 (which may also be referred to herein as a network node).

Base stations are not the only entities that may function as scheduling entities. That is, in some examples, a UE or network node may function as a scheduling entity, scheduling resources for one or more scheduled entities (e.g., one or more UEs).

As illustrated in FIG. 1, a network node 108 may broadcast downlink traffic 112 to one or more UEs 106. Broadly, the network node 108 is a node or device responsible for scheduling traffic in a wireless communication network, including downlink traffic 112 and, in some examples, uplink traffic 116 from one or more UEs 106 to the network node 108. On the other hand, the UE 106 is a node or device that receives downlink control information 114, including but not limited to scheduling information (e.g., a grant), synchronization or timing information, or other control information from another entity in the wireless communication network such as the network node 108.

In general, network nodes 108 may include a backhaul interface for communication with a backhaul portion 120 of the wireless communication system. The backhaul 120 may provide a link between a network node 108 and the core network 102. Further, in some examples, a backhaul network may provide interconnection between the respective network nodes 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

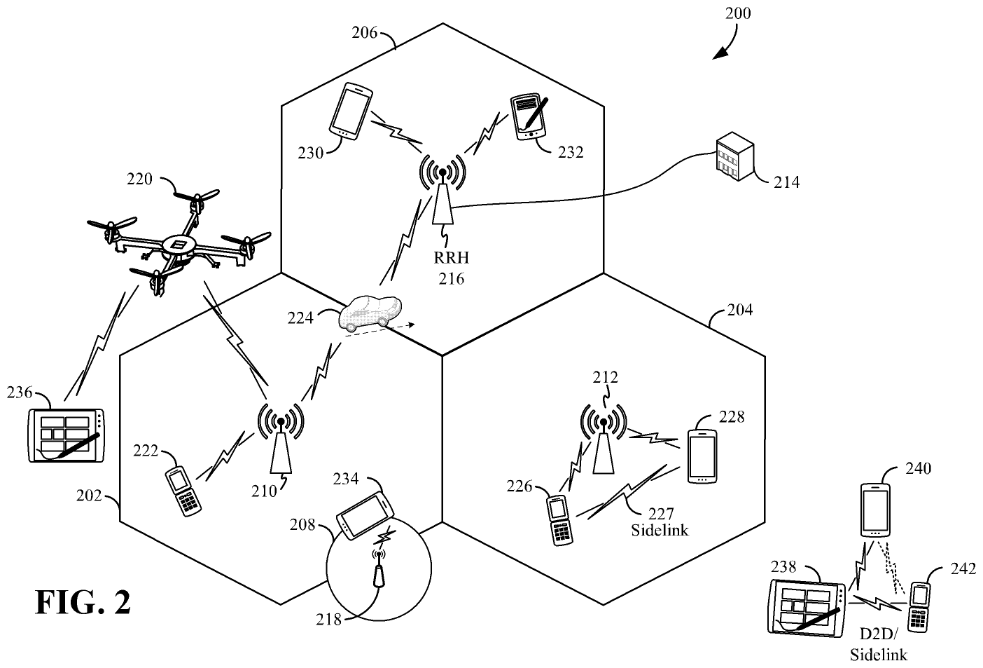

FIG. 2 is a conceptual diagram illustrating an example of a radio access network according to some aspects of this disclosure. By virtue of a RAN 200, one or more wireless UE may be enabled to carry out data communication with an external data network, such as (but not limited to) the Internet.

The RAN 200 may implement any suitable wireless communication technology or technologies to provide radio access. As one example, the RAN 200 may operate according to 3GPP NR specifications, often referred to as 5G or 5G NR. In some examples, the RAN 200 may operate under a hybrid of 5G NR and eUTRAN standards, often referred to as LTE. 3GPP refers to this hybrid RAN as a next-generation RAN, or NG-RAN. Of course, many other examples may be utilized within the scope of the present disclosure.

As illustrated, the RAN 200 includes a plurality of base stations (e.g., base stations 210, 212, and 214). The geographic area covered by the RAN 200 may be divided into cellular regions (cells) that a UE can uniquely identify based on an identification broadcasted from one access point or base station. Broadly, a base station is a network element in a radio access network responsible for radio transmission and reception in one or more cells to or from a UE. In different technologies, standards, or contexts, those skilled in the art may variously refer to a “base station” as a network node, a base transceiver station (BTS), a radio base station, a radio transceiver, a transceiver function, a basic service set (BSS), an extended service set (ESS), an access point (AP), a Node B (NB), an eNode B (eNB), a gNode B (gNB), or some other suitable terminology. FIG. 2 illustrates macrocells 202, 204, and 206, and a small cell 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

The example of FIG. 2 shows two base stations 210 and 212 in cells 202 and 204; and shows a third base station 214 controlling a remote radio head (RRH) 216 in cell 206. That is, a base station can have an integrated antenna or can be connected to an antenna or RRH by feeder cables. In the illustrated example, the cells 202, 204, and 206 may be referred to as macrocells, as the base stations 210, 212, and 214 support cells having a large size. Further, a base station 218 is shown in the small cell 208 (e.g., a microcell, picocell, femtocell, home base station, home Node B, home eNode B, etc.) which may overlap with one or more macrocells. In this example, the cell 208 may be referred to as a small cell, as the base station 218 supports a cell having a relatively small size. Cell sizing can be done according to system design as well as component constraints.

The RAN 200 may include any number of wireless base stations and cells. Further, a RAN may include a relay node to extend the size or coverage area of a given cell. The base stations 210, 212, 214, 218 provide wireless access points to a core network for any number of mobile apparatuses. The example of FIG. 2 further includes a quadcopter 220 or drone, which may be configured to function as a base station. That is, in some examples, a cell may not necessarily be stationary, and the geographic area of the cell may move according to the location of a mobile base station such as the quadcopter 220.

The RAN 200 supports wireless communication for multiple mobile apparatuses. Those skilled in the art may refer to a mobile apparatus as a UE, as in 3GPP specifications, but may also refer to a UE as a MS, a subscriber station, a mobile unit, a subscriber unit, a wireless unit, a remote unit, a mobile device, a wireless device, a wireless communication device, a remote device, a mobile subscriber station, an AT, a mobile terminal, a wireless terminal, a remote terminal, a handset, a terminal, a user agent, a mobile client, a client, or some other suitable terminology. A UE may be an apparatus that provides access to network services. A UE may take on many forms and can include a range of devices.

Within the present document, a “mobile” apparatus (aka a UE) need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cell phone, a smart phone, a SIP phone, a laptop, a PC, a notebook, a netbook, a smartbook, a tablet, a PDA, and a broad array of embedded systems, e.g., corresponding to an IoT. A mobile apparatus may additionally be an automotive or other transportation vehicle, a remote sensor or actuator, a robot or robotics device, a satellite radio, a GPS device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment; military defense equipment, vehicles, aircraft, ships, and weaponry, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data. A mobile apparatus may additionally include two or more disaggregated devices in communication with one another, including, for example, a wearable device, a haptic sensor, a limb movement sensor, an eye movement sensor, etc., paired with a smartphone. In various examples, such disaggregated devices may communicate directly with one another over any suitable communication channel or interface, or may indirectly communicate with one another over a network (e.g., a local area network or LAN).

Within the RAN 200, the cells may include UEs that may be in communication with one or more sectors of each cell. Further, each base station 210, 212, 214, 218, and 220 may be configured to provide an access point to a core network for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station (e.g., quadcopter 220). In some examples, the UEs 222, 224, 226, 228, 230, 232, 234, 236, 238, 240, and/or 242 may be the same as the UE/scheduled entity 106 described above and illustrated in FIG. 1. In some examples, a mobile network node (e.g., quadcopter 220) may be configured to function as a UE. For example, the quadcopter 220 may operate within cell 202 by communicating with base station 210.

Wireless communication within the RAN 200 may be described as utilizing an air interface. Transmissions over the air interface from a base station to one or more UEs may be referred to as DL transmission. In accordance with certain aspects of the present disclosure, the term downlink may refer to a point-to-multipoint transmission originating at a scheduling entity, such as a base station or gNB. Another way to describe this scheme may be to use the term broadcast channel multiplexing. Transmissions from a UE to a scheduling entity may be referred to as UL transmissions. In accordance with further aspects of the present disclosure, the term uplink may refer to a point-to-point transmission originating at a scheduled entity, such as a UE.

In some examples, access to the air interface may be scheduled, wherein a scheduling entity allocates resources for communication among some or all devices and equipment within its service area or cell. Within the present disclosure, a scheduling entity may be responsible for scheduling, assigning, reconfiguring, and releasing resources for one or more scheduled entities. That is, for scheduled communication, UEs, which may be scheduled entities, may utilize resources allocated by the scheduling entity.

Base stations are not the only entities that may function as scheduling entities. That is, in some examples, a UE may function as a scheduling entity, scheduling resources for one or more scheduled entities (e.g., one or more other UEs). In particular, device-to-device communications such as SL communications may employ modified channel access mechanisms.

Broadly, a scheduling entity is a node or device responsible for scheduling traffic in a wireless communication network, including downlink traffic and, in some examples, uplink traffic from one or more scheduled entities to the scheduling entity. On the other hand, a scheduled entity is a node or device that receives downlink control information, including but not limited to scheduling information (e.g., a grant), synchronization or timing information, or other control information from another entity in the wireless communication network such as the scheduling entity.

In a further aspect of the RAN 200, SL signals may be used between UEs without necessarily relying on scheduling or control information from a base station or scheduling entity. For example, two or more UEs (e.g., UEs 226 and 228) may communicate with each other using peer to peer (P2P) or SL signals 227 without relaying that communication through a base station (e.g., base station 212). In a further example, UE 238 is illustrated communicating with UEs 240 and 242. Here, the UE 238 may function as a scheduling entity or a primary SL device, and UEs 240 and 242 may function as a scheduled entity or a non-primary (e.g., secondary) SL device. In some examples, SL communications may occur between two devices, rather than three as shown. In still another example, a UE may function as a scheduling entity in a device-to-device (D2D), peer-to-peer (P2P), or vehicle-to-vehicle (V2V) network, and/or in a mesh network. In a mesh network example, UEs 240 and 242 may optionally communicate directly with one another in addition to communicating with the scheduling entity 238. Thus, in a wireless communication system with scheduled access to time-frequency resources and having a cellular configuration, a P2P configuration, or a mesh configuration, a scheduling entity and one or more scheduled entities may communicate utilizing the scheduled resources.

Some of the wireless resources of the RAN 200 may carry one or more physical channels, including control channels, shared channels, data channels, etc. Other resources of the RAN 200 may also carry pilots or reference signals. These pilots or reference signals may provide for a receiving device to perform channel estimation of the corresponding channel, which may enable coherent demodulation/detection of the control and/or data channels.

In a DL transmission, the transmitting device (e.g., a scheduling entity) may allocate suitable resources to carry one or more DL control channels. These DL control channels include DL control information (DCI) that generally carries information originating from higher layers, such as a physical broadcast channel (PBCH), a physical downlink control channel (PDCCH), etc., to one or more scheduled entities 106. In addition, the transmitting device may allocate DL resources to carry DL physical signals that generally do not carry information originating from higher layers. These DL physical signals may include a primary synchronization signal (PSS); a secondary synchronization signal (SSS); demodulation reference signals (DM-RS); phase-tracking reference signals (PT-RS); channel-state information reference signals (CSI-RS); etc.

The PDCCH may carry DCI for one or more UEs in a cell. This can include, but is not limited to, power control commands, scheduling information, a grant, and/or an assignment of REs for DL and UL transmissions.

In an UL transmission, a transmitting device (e.g., a scheduled entity) may utilize scheduled resources to carry one or more UL control channels, such as a physical uplink control channel (PUCCH), a physical random access channel (PRACH), etc. These UL control channels include UL control information (UCI) that generally carries information originating from higher layers. Further, UL resources may carry UL physical signals that generally do not carry information originating from higher layers, such as demodulation reference signals (DM-RS), phase-tracking reference signals (PT-RS), sounding reference signals (SRS), etc. In some examples, the UCI may include a scheduling request (SR), i.e., a request for a scheduling entity to schedule resources for uplink transmissions. Here, in response to the SR, the scheduling entity may transmit DCI that may schedule resources for UL packet transmissions.

UL control information may also include hybrid automatic repeat request (HARQ) feedback such as an acknowledgment (ACK) or negative acknowledgment (NACK), channel state information (CSI), or any other suitable UL control information. HARQ is a technique well-known to those of ordinary skill in the art, wherein a receiving device can check the integrity of packet transmissions for accuracy, e.g., utilizing any suitable integrity checking mechanism, such as a checksum or a cyclic redundancy check (CRC). If the receiving device confirms the integrity of the transmission, it may transmit an ACK, whereas if not confirmed, it may transmit a NACK. In response to a NACK, the transmitting device may send a HARQ retransmission, which may implement chase combining, incremental redundancy, etc.

In addition to control information, wireless resources in the RAN 200 may be allocated for user data or traffic data. Such traffic may be carried on one or more traffic channels, such as, for a DL transmission, a physical downlink shared channel (PDSCH); or for an UL transmission, a physical uplink shared channel (PUSCH).

The channels or carriers described above are not necessarily all the channels or carriers that may be utilized between a scheduling entity 108 and scheduled entities 106, and those of ordinary skill in the art will recognize that other channels or carriers may be utilized in addition to those illustrated, such as other traffic, control, and feedback channels.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, gNB, access point (AP), a transmit receive point (TRP), or a cell, etc.) may be implemented as an aggregated base station (also known as a standalone BS or a monolithic BS) or a disaggregated base station. In the present disclosure, reference to a gNB, network node, or base station broadly refers to aggregated and disaggregated examples.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, e.g., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

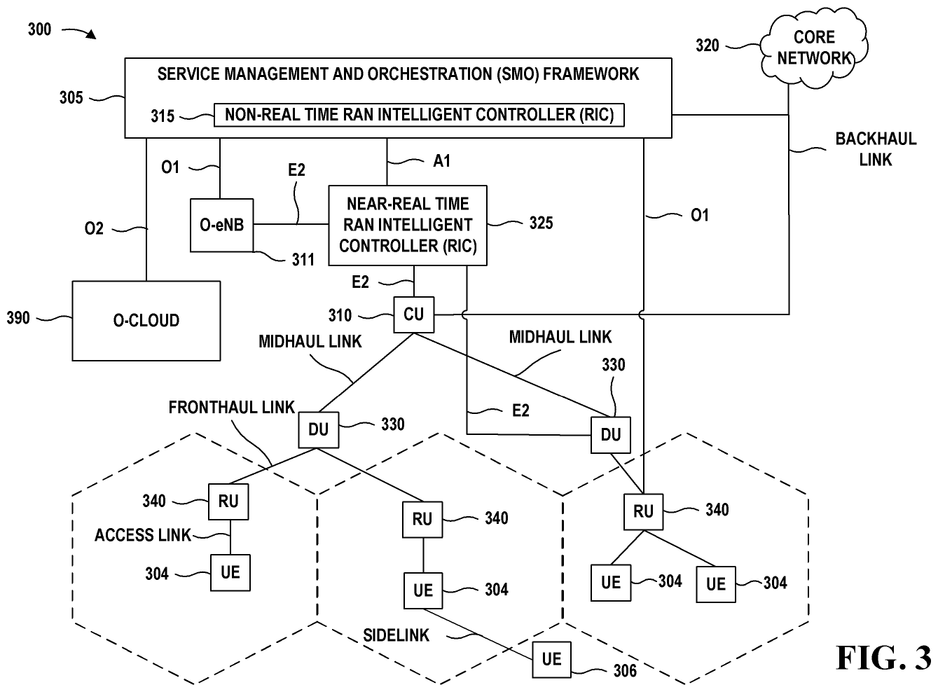

FIG. 3 is a schematic diagram illustrating an example distributed base station architecture according to some aspects of this disclosure. Distributed (or disaggregated) base station 300 architecture may include one or more CUs 310 that may communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more DUs 330 via respective midhaul links, such as an F1 interface. The DUs 2330 may communicate with one or more RUs 340 via respective fronthaul links. The RUs 2340 may communicate with respective UEs 104/106 via one or more RF access links (e.g., a Uu interface). In some implementations, the UE 104/106 may be simultaneously served by multiple RUs 340. In some examples, as described above, UEs 104/106 may communicate with one another through a direct device-to-device SL interface.

Each of the units, e.g., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include RRC, packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a MAC layer, and one or more high PHY layers (such as modules for forward error correction (FEC) encoding and decoding, scrambling, modulation and demodulation, or the like) depending, at least in part, on a functional split, such as those defined by 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 106. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

### Sidelink

D2D communication may employ a different set of channels or resources than those used for UL and DL communication. D2D, or point-to-point (P2P) communication enables discovery of, and communication with nearby devices using a direct link between the devices (e.g., without passing through a base station, relay, or other node). D2D can enable mesh networks, and device-to-network relay functionality. Some examples of D2D technology include Bluetooth pairing, Wi-Fi Direct, Miracast, LTE-D, and SL communication.

SL communication may be provided over a PC5 interface, which employs PC5 protocols for D2D communication. Other suitable protocols may be utilized for SL communication within the scope of this disclosure.

Resource allocation for wireless resources in a SL resource pool may employ one of two modes, referred to herein as mode 1 and mode 2. In mode 1, which may be referred to as scheduled resource allocation, the SL resource allocation is provided by the network. In mode 2, which may be referred to as UE autonomous resource allocation, a UE decides the SL transmission resources and timing in the resource pool.

Resource allocation mode 1 may generally be managed by a scheduling entity or gNB (e.g., an aggregated or disaggregated base station). In some examples, a UE 304 may transmit an SL buffer status report (BSR) to a gNB to support scheduling of SL resources via resource allocation mode 1. A SL BSR indicates that a UE 304 has data buffered or ready for transmission over SL to a destination UE 304-Rx/306. And in some examples, a gNB may use one of several different types of SL grants.

With a type-1 SL configured grant, which may be referred to as a static grant, a gNB may employ higher-layer (e.g., RRC) signaling to provide resources for a persistent SL grant for SL communication.

With a type-2 SL configured grant, which may be referred to as a semi-static grant, a gNB may transmit a suitable DCI on the PDCCH to either activate or deactivate the resources for SL grant. With a dynamic grant, a gNB may transmit a suitable DCI on the PDCCH that itself includes a SL grant. Because a dynamic grant may arrive at essentially any time, a UE may continuously monitor the PDCCH for such dynamic SL grant DCIs.

With resource allocation mode 2 a UE may autonomously, or on its own, select resources for SL transmissions from a SL resource pool designated by the RAN. The UE autonomous resource selection technique involves a UE sensing the resources in the resource pool and based on the sensing, selecting and reserving SL resources. This includes an autonomous UE determination of how many times to transmit, repeat, or retransmit a given transmission. Those of ordinary skill in the art will recognize that in many scenarios, resource allocation mode 1 may be more suitable for UEs that are located within a gNB's coverage area, while resource allocation mode 2 may be more suited for UEs that are outside a gNB's coverage area. Furthermore, resource allocation mode 2 may be employed for groupcast or broadcast transmissions where a negotiation between UEs to establish an RRC connection for the SL is not available.

SL communication may employ several physical channels and physical signals. For example, a physical SL control channel (PSCCH) may be used to indicate resource and other transmission parameters that a UE uses for transmission of data on a physical SL shared channel (PSSCH). Transmission via the PSCCH may generally include a DM-RS.

UEs may use the PSSCH to transmit data information, as well as certain control information for HARQ techniques and CSI feedback triggers, etc. PSSCH transmissions may generally include a DM-RS and may be associated with a PT-RS.

A physical SL feedback channel (PSFCH) carries HARQ feedback over the SL. A UE that is an intended recipient of a PSSCH transmission may transmit HARQ feedback via the PSFCH to the UE that performed the transmission.

A SL synchronization signal may include SL primary and SL secondary synchronization signals (S-PSS, S-SSS), and may be broadcast along with a physical SL broadcast channel (PSBCH).

SL HARQ feedback uses the PSFCH. In some examples, the PSFCH may transmit either ACK or NACK using a resource dedicated to a single PSFCH-transmitting UE. In another example, the PSFCH may carry a NACK, or no PSFCH signal may transmitted. That is, in some examples, SL HARQ feedback via the PSFCH may be disabled. In SL resource allocation mode 1, a UE that receives SL HARQ feedback via the PSFCH can report this feedback to a gNB via PUCCH or PUSCH.

In some examples, a UE using SL may transmit a channel state information reference signal (CSI-RS) for CSI measurement and reporting in the SL. A receiving UE may transmit the CSI report utilizing a suitable feedback or control message, for example, in a medium access control-control element (MAC-CE). In addition, a UE may measure configured SL resource pools for reporting a channel busy ratio (CBR). CBR reports may be periodic or event-triggered based on an overloaded channel and/or a low-loaded channel. Based on the CBR, a UE may adapt one or more transmission parameters for SL transmission, such as its maximum transmission power, the number of retransmissions to make, the MCS, and others.

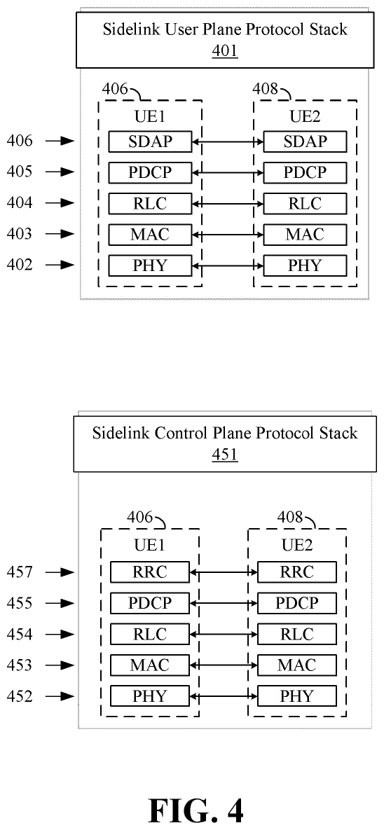

FIG. 4 is a block diagram illustrating a radio protocol architecture for SL communication according to some aspects of this disclosure. SL radio bearers may be categorized into two groups: SL data radio bearers for user plane data and SL signaling radio bearers for control plane data. The example of FIG. 4 shows a user plane protocol stack 401 and a control plane protocol stack 451 for a SL interface between a pair of UEs (labeled UE1 406 and UE2 408) in accordance with some aspects of this disclosure. The illustrated SL radio protocol architecture is illustrated with a user plane protocol stack 401 and a control plane protocol stack 451, showing their respective layers or sublayers. Radio bearers between a first UE 406 and a second UE 408 may be categorized as data radio bearers (DRB) for carrying user plane data, corresponding to the user plane protocol 401; and signaling radio bearers (SRB) for carrying control plane data, corresponding to the control plane protocol 451.

Both the user plane 401 and control plane 451 protocols include a PHY layer 402/452, a MAC layer 403/453, a radio link control layer (RLC) 404/454, and a packet data convergence protocol layer (PDCP) 405/455. PHY 402/452 is the lowest layer and implements various physical layer signal processing functions. The MAC layer 403/453 provides radio resource selection, packet filtering, priority handling between UL and DL transmissions for a given UE, and SL CSI reporting. The RLC layer 404/454 provides functions such as sequence numbering, segmentation and reassembly of upper layer data packets, and duplicate packet detection. The PDCP layer 405/455 provides functions including header compression for upper layer data packets to reduce radio transmission overhead, security by ciphering the data packets, and integrity protection and verification.

In the user plane protocol stack 401, a service data adaptation protocol (SDAP) layer 406 provides services and functions for maintaining a desired QoS, including mapping between a QoS flow and a SL data radio bearer. QoS broadly refers to the collective effect of service performances which determine the degree of satisfaction of a user of a service. QoS is characterized by the combined aspects of performance factors applicable to all services, such as: service operability performance; service accessibility performance; service retainability performance; service integrity performance; and other factors specific to each service.

And in the control plane protocol stack 451, an RRC layer 457 includes a number of functional entities for transferring RRC messages between paired UEs, for maintenance and release of an RRC connection between UEs, and for detection of a SL radio link failure.

An RRC layer corresponding to the Uu interface (not illustrated) also may include various SL-specific services and functions. For example, using the Uu interface, an RRC entity may configure SL resource allocation via system information signaling or dedicated signaling. This RRC entity may further be used for measurement configuration and reporting related to the SL, and for communication or reporting of UE assistance information relating to SL traffic patterns. That is, a UE may report SL traffic patterns to the RAN.

SL communications may be supported by a source identifier (ID) and a destination ID. For example, a source layer-2 ID may identify the source, or sender of SL data. A destination layer-2 ID may identify the target, or receiver of SL data. Further, a PC5 link ID may be used to uniquely identify a PC5 unicast link in a UE for the lifetime of the PC5 unicast link.

SL transmissions may generally fall within one of three transmission types: a unicast transmission, a groupcast transmission, or a broadcast transmission. With unicast transmissions, paired UEs can establish an RRC connection and negotiate the configuration of their mutual SL interface. Paired UEs can detect a radio link failure of their RRC connection, and can transmit and receive control information and user traffic over a SL, including the use of SL HARQ feedback.

With groupcast transmissions, a transmitting UE can transmit user traffic to one or more UEs belonging to a group in SL. Here, a group may be identified based on respective UEs'destination layer-2 IDs. That is, UEs in a given group for a SL groupcast may share the same destination layer-2 ID. Broadcast transmissions are similar to groupcast, and are directed to a set of UEs that share a destination layer-2 ID.

### Uu DRX

DRX is a power saving feature that allows a UE to avoid continuously, or too-frequently monitoring the air interface for any data to be received. In a DRX mode of operation, a UE may save power by entering a low power (“sleep”) mode (also referred to herein as a sleep phase, an inactive mode, or a low power state where at least a portion of a UE's receiver circuitry switched off) for a certain period of time referred to as a DRX off-phase or duration. To maintain communication with the network, however, the DRX-enabled UE may wake up again during a DRX on-phase or on-duration (e.g., an active mode or awake phase). During the on-duration, a UE is awake, and may perform continuous reception or monitoring while waiting for a transmission. Thus, when DRX is configured, a UE is not required to continuously monitor the PDCCH(s), and monitors, e.g., one paging occasion per DRX cycle. This cycle of sleep and wake-up (DRX off and DRX on) durations repeats according to a configured DRX cycle time.

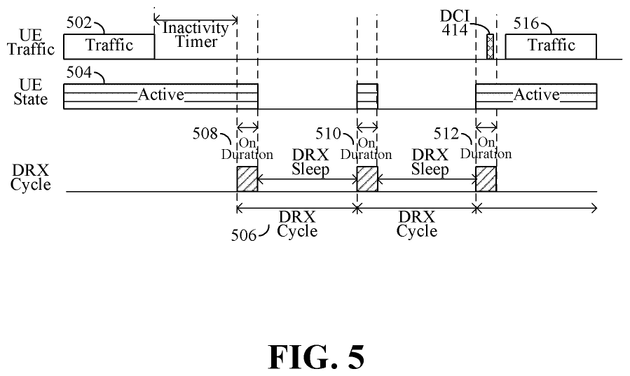

FIG. 5 is a timing diagram illustrating example DRX techniques according to some aspects of this disclosure. The illustration includes three time-aligned rows showing UE traffic, a UE state, and a DRX cycle, over time. The UE traffic row shows downlink transmissions to the UE, as an example. The UE state shows an RRC state for the UE. And the DRX cycle row shows the DRX modes. As shown, the timeline begins with a UE receiving first DL traffic 502. During this time, the UE is shown in an active state 504.

When the first DL traffic 502 ends, the illustrated example shows a UE starting a DRX inactivity timer. However, those of ordinary skill in the art will recognize that in some examples, a DRX inactivity timer may start based on reception of DL control information rather than, or in addition to, DL traffic. For example, a UE's DRX inactivity timer may start (or restart) when the UE successfully receives and decodes a PDCCH that schedules an initial transmission on the Uu interface. In some examples, the DRX inactivity timer may not be affected by receipt of a PDCCH that schedules a HARQ retransmission on the Uu interface. The DRX inactivity timer is utilized to clock the time for a UE to wait for a successful receipt and decoding of the PDSCH.

Returning to FIG. 5, after the first traffic 502 ends, the UE is shown remaining in the active state 504 for the duration of the running of the inactivity timer. When no UE traffic is received for the duration of the inactivity timer, a first DRX cycle 506 begins and (in some examples, after a certain DRX slot offset) the UE's DRX cycle begins on on-duration 508 and the UE starts an on-duration timer. The on-duration timer defines the time interval (the on-duration 508 ) when a UE should expect to receive a PDCCH; the DRX slot offset refers to the delay, in slots, before the on-duration timer starts.

In the illustrated example, the UE does not receive a DL transmission during the first on-duration 508 (e.g., before the on-duration timer expires). Thus, the UE may enter into a low-power state for a duration based on a DRX cycle timer. Here, the DRX cycle timer clocks the period of the on-duration 508, potentially followed by a period of inactivity. At the expiry of the DRX cycle timer, the DRX cycle enters a second on-duration 510, and the UE again enters an active state and monitors for any data transmissions. Here, because no data is received during the second on-duration 510 (e.g., before the expiry of the on-duration timer), the DRX cycle again enters into the low-power state. In a third DRX on-duration 512, however, while the UE is in an active state, the illustrated example shows a DCI 514 received by the UE on a PDCCH. Because the UE receives and decodes the DCI 514, the UE starts its DRX inactivity timer and remains active to monitor for the scheduled traffic 516.

### Sidelink DRX

In some networks that employ SL communications, a similar DRX feature may not be defined for the SL operations. In these networks, a RX UE monitors a SL for SCI in each time slot. A SL DRX design for these applications can accordingly reduce power consumption. This can also improve power saving for battery power-confined UEs, such as pedestrian UEs for Vehicle-to-Person (V2P) service on SL, or UEs for public safety services on SL.

A SL DRX configuration is conceptually similar to that for the Uu interface, described above. That is, a SL DRX cycle includes SL DRX on phases or durations, and sleep phases or durations. A transmitter (Tx) UE is awake during the DRX on phases to communicate with an Rx UE for unicast or with Rx UEs for broadcast and groupcast. For example, an Rx UE may monitor for signaling that may be received from the Tx UE. Both Tx UE and Rx UE(s) are in a low power state (e.g., sleep phase) at other times. In addition, a UE of a service, a group, or a UE pair, becomes a Tx UE on SL when it has a packet to transmit on SL to the other UEs of a service or a group or to the other UE of a UE pair.

### Scheduling Entity/gNB

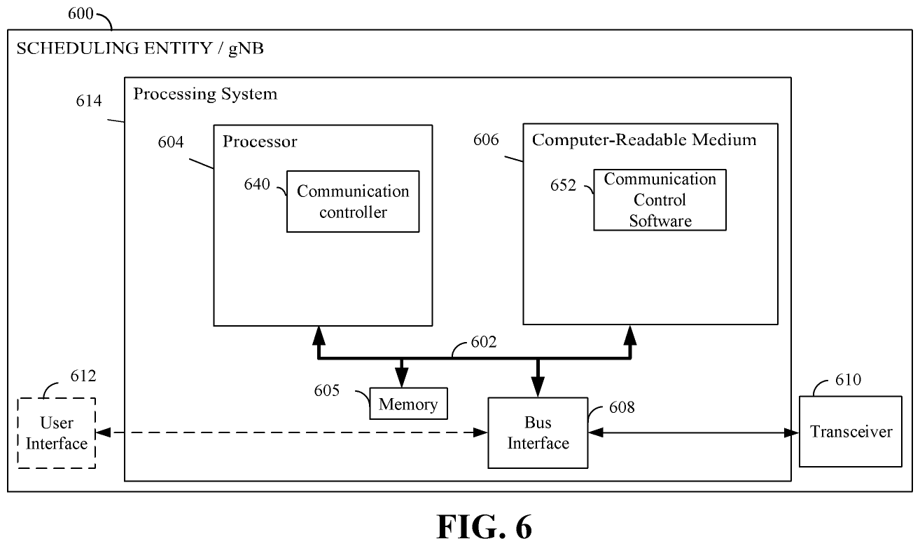

FIG. 6 is a block diagram illustrating an example of a hardware implementation for a scheduling entity or gNB according to some aspects of this disclosure. In the example of FIG. 6, a hardware implementation for a scheduling entity 600 employing a processing system 614 is shown. For example, the scheduling entity 600 may be a UE as illustrated in any one or more of the FIGS. of this disclosure. In another example, the scheduling entity 600 may be a base station or gNB as illustrated in any one or more of FIGS. of this disclosure.

The scheduling entity 600 may include a processing system 614 having one or more processors 604. Examples of processors 604 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the scheduling entity 600 may be configured to perform any one or more of the functions described herein.

The processing system 614 may be implemented with a bus architecture, represented generally by the bus 602. The bus 602 may include any number of interconnecting buses and bridges depending on the specific application of the processing system 614 and the overall design constraints. The bus 602 communicatively couples together various circuits including one or more processors (represented generally by the processor 604), a memory 605, and computer-readable media (represented generally by the computer-readable medium 606). The bus 602 may also link various other circuits such as timing sources, peripherals, voltage regulators, and power management circuits, which are well known in the art, and therefore, will not be described any further. A bus interface 608 provides an interface between the bus 602 and a transceiver 610. The processor may use the bus interface 608 to output messages or signals to the transceiver 610. The transceiver 610 provides a communication interface or means for communicating with various other apparatus over a transmission medium. Depending upon the nature of the apparatus, a user interface 612 (e.g., keypad, display, speaker, microphone, joystick) may also be provided. Of course, such a user interface 612 is optional, and some examples, such as a base station, may omit it.

In some aspects of the disclosure, the processor 604 may include communication control circuitry 640 configured (e.g., in coordination with the memory 605 and/or communication control software 652) for various functions, including, e.g., scheduling and communicating with one or more UEs.

The processor 604 is responsible for managing the bus 602 and general processing, including the execution of software stored on the computer-readable medium 606. The software, when executed by the processor 604, causes the processing system 614 to perform the various functions described below for any particular apparatus. The processor 604 may also use the computer-readable medium 606 and the memory 605 for storing data that the processor 604 manipulates when executing software.

One or more processors 604 in the processing system may execute software. Software shall be construed broadly to mean instructions, instruction sets, code, code segments, program code, programs, subprograms, software modules, applications, software applications, software packages, routines, subroutines, objects, executables, threads of execution, techniques, functions, etc., whether referred to as software, firmware, middleware, microcode, hardware description language, or otherwise. The software may reside on a computer-readable medium 606. The computer-readable medium 606 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 606 may reside in the processing system 614, external to the processing system 614, or distributed across multiple entities including the processing system 614. The computer-readable medium 606 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

### Scheduled Entity/UE

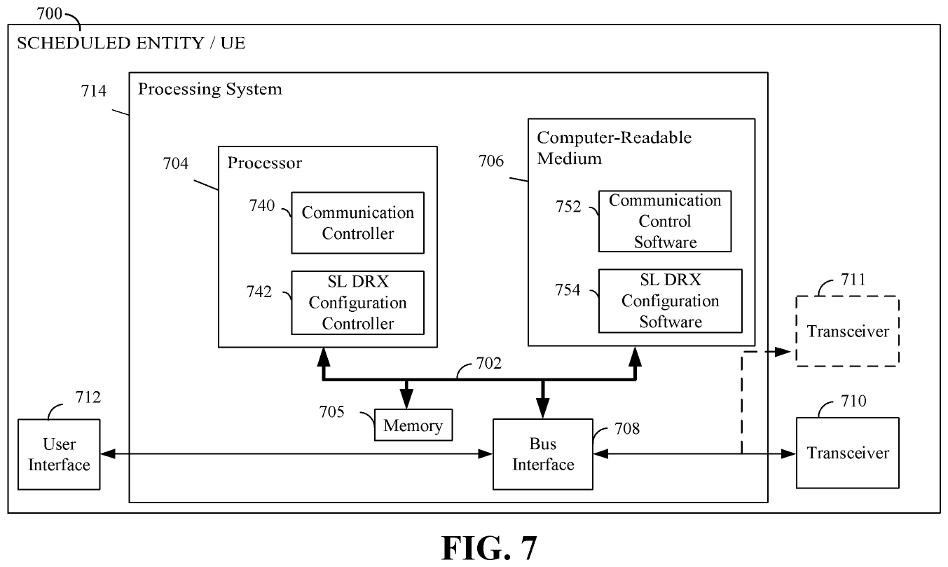

FIG. 7 is a block diagram illustrating an example of a hardware implementation for a scheduled entity or UE according to some aspects of this disclosure. The example of FIG. 7 depicts scheduled entity 700 employing a processing system 714. In accordance with various aspects of the disclosure, the processing system 714 may include an element, or any portion of an element, or any combination of elements having one or more processors 704. For example, the scheduled entity 700 may be a UE as illustrated in any one or more FIGS. of this disclosure.

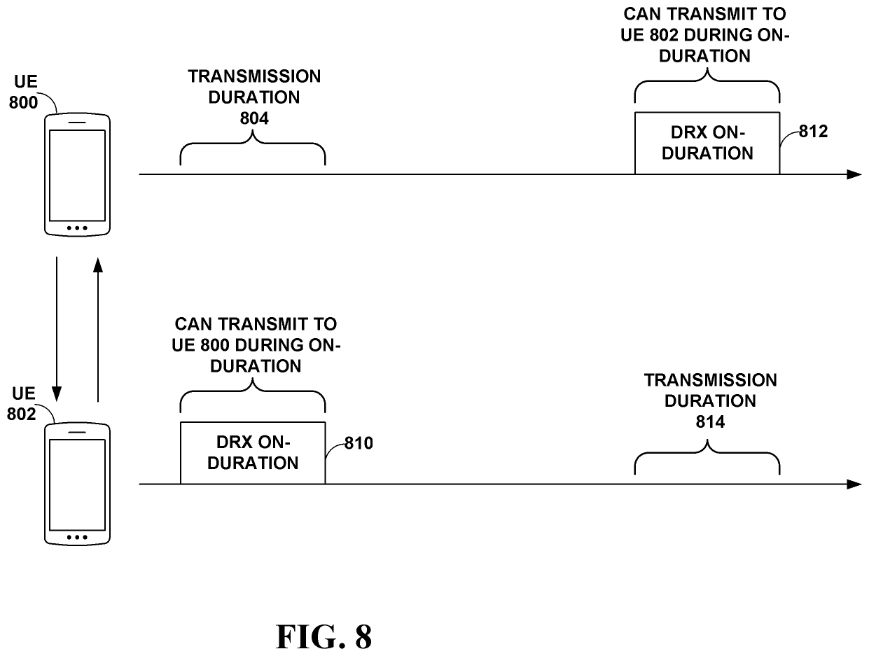

The processing system 714 may be substantially the same as the processing system 614 illustrated in FIG. 6, including a bus interface 708, a bus 702, memory 705, a processor 704, and a computer-readable medium 706. Furthermore, the scheduled entity 700 may include a user interface 712 and a transceiver 710 substantially similar to those described above in FIG. 6. That is, the processor 704, as utilized in a scheduled entity 700, may be configured (e.g., in coordination with the memory 705) to implement any one or more of the techniques described below and illustrated in FIGS. 8-16.

In some aspects of the disclosure, the processor 704 may include communication control circuitry 740 configured (e.g., in coordination with the memory 705 and/or communication control software 752) for various functions, including, e.g., communicating with one or more scheduling entities over a Uu interface, and/or communicating with one or more UEs over a SL interface. The processor 704 may further include SL DRX configuration controller 742 configured (e.g., in coordination with the memory 705 and/or SL DRX configuration software 754) for various functions, including, e.g., configuring transmission durations and/or DRX on-durations for transmission and/or reception of traffic, such as extending DRX on-durations into transmission durations.

In traditional SL DRX, when a PHY layer is indicated with an active time of an RX UE from MAC layer for candidate resource selection, a restriction is applied in the PHY layer so that at least a subset of candidate resources reported to the MAC layer is located within the indicated active time of the RX UE. If none of the candidate resources are within the RX UE's active time, the UE implementation should add at least one resource that is within the active time.

In SL-unlicensed (SL-U), the UE performs listen before talk (LBT) before a transmission in order to avoid a collision with transmission(s) from another device(s) using the same resource(s). In other words, the UE may first determine that no other devices are transmitting via the resource(s) before starting to transmit. In some instances, a UE, after first selecting a set of resources, may fail LBT (e.g., another device(s) is transmitting over the same set of resources), which would trigger an LBT failure at the MAC layer. Two possible ways of handling such an LBT failure may include 1) issuing a resource re-selection at the MAC layer; or 2) using a re-transmission occasion for the initial transmission. Based on these conditions, if C-DRX is used in SL-U, the resource selected by the UE implementation may suffer from more interference than otherwise, increasing the probability of an LBT failure. Additionally, a frequent resource re-selection or insufficient resources may impede throughput.

In traditional SL DRX, a UE may be a transmit (TX) UE during a transmission duration of the UE. The transmission duration may be a predetermined period of time when the UE is permitted to transmit packets to a RX UE. The UE may be an RX UE during a DRX on-duration of the UE. The DRX on-duration may be a predetermined period of time when the UE may perform SCI monitoring for packets from a TX UE.

When using SL-U C-DRX with bidirectional traffic between two UEs, one possible solution to lessen the probability of an LBT failure is to extend the DRX on-duration (e.g., the time when a RX UE is SCI monitoring for packets from a TX UE in the transmission duration (e.g., the time traditionally reserved for monitoring SCI for packets from another UE)). In such a case, the TX UE not only performs transmission during the pre-negotiated DRX on-duration of the RX UE, but also performs transmission in the DRX on-duration of the TX UE. A UE may perform SCI monitoring during the transmission duration of that UE (the UE performing the SCI monitoring) when that UE is not transmitting. However, since the UE may not only perform transmission during its transmission duration, but also may perform SCI monitoring during its transmission duration, it may not be possible to transmit and receive at the same time which would result in a collision. As such, any collision should be avoided.

FIG. 8 is a conceptual diagram illustrating example SL communication techniques between two UEs according to some aspects of this disclosure. A UE 800 and/or a UE 802 may be examples of other UEs set forth herein, such as scheduled entity/UE 700. For example, the UE 800 may have transmission duration 804 during which the UE 800 may transmit to the UE 802. During the transmission duration 804, if the UE 800 is not transmitting, UE 800 may monitor SCI for transmissions from UE 802. UE 802 may have a transmission duration 814 during which the UE 802 may transmit to the UE 800. During the transmission duration 814, if the UE 802 is not transmitting, the UE 802 may monitor SCI for transmissions from the UE 800.

The UE 802 may have a DRX on-duration 810 during which the UE 802 may be in an awake mode and ready to receive transmissions from the UE 800. The UE 800 may similarly have a DRX on-duration 812 during which the UE 800 may be in an awake mode and ready to receive transmissions from the UE 802. According to the techniques of this disclosure, the UE 802 may also transmit during its own DRX on-duration 810 and/or the UE 800 may transmit during its own DRX on-duration 812. Because both the UE 800 and the UE 802 may transmit during a same time period (e.g., the time period corresponding to the transmission duration 804 and the DRX on-duration 810, and/or the time period corresponding to the DRX on-duration 812 and the transmission duration 814), techniques for collision avoidance may be desirable.

In some examples, the UE 800 may actively indicate whether the UE 800 will extend the DRX on-duration 812 during the transmission duration 804 of the UE 800, thereby enabling the UE 800 to receive during the transmission duration 804 and the UE 802 to transmit during the DRX on-duration 810. In some examples, the UE 800 may passively receive a suggestion from the UE 802 of whether the UE 800 extend the DRX on-duration 812 during the transmission duration 804, thereby enabling the UE 800 to receive during the transmission duration 804 and the UE 802 to transmit during the DRX on-duration 810.

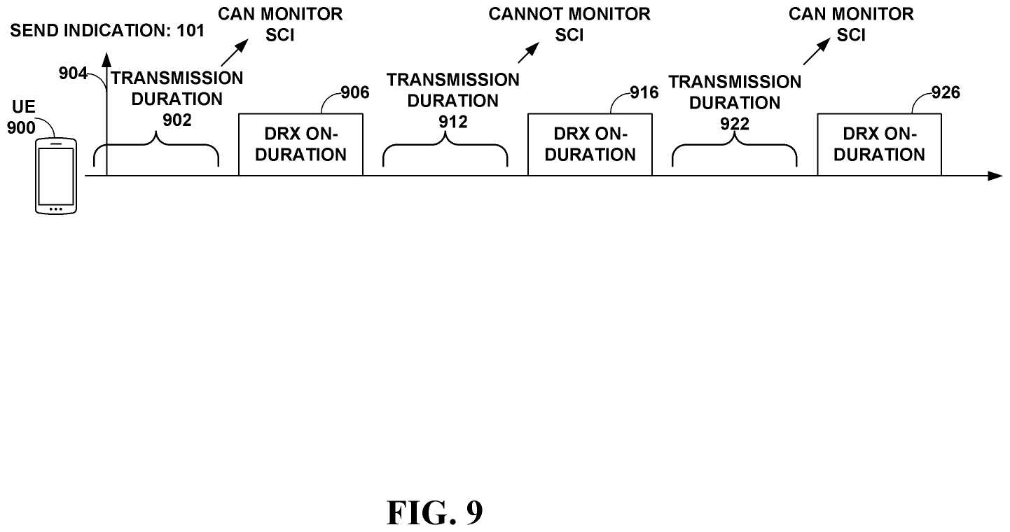

FIG. 9 is a conceptual diagram illustrating example SL communication techniques for actively indicating to extend a DRX on-duration according to some aspects of this disclosure. For example, a UE 900 (which may be an example of other UEs set forth herein, such as scheduled entity/UE 700) may send an indication 904 to another UE during a transmission duration 902, typically a pre-negotiated time during which the other UE is monitoring SCI for transmission from the UE 900.

For example, the UE 900 may indicate, via the indication 904, whether or not the UE 900 may extend the DRX on-duration (e.g., DRX on-duration(s) 906, 916, and/or 926) during a transmission duration, such as the transmission duration 902 as shown, via signaling, such as SCI-2 (e.g., the second stage of SCI), MAC-CE, or PC-5 RRC signaling. SCI is typically transmitted in two stages. The first stage of SCI, which may be referred to as SCI-1, may be carried via PSCCH and may include information relating to sensing operations and information for allocation of resources of PSSCH. The second stage of SCI, which may be referred to as SCI-2, may be carried by the PSSCH and may include information to identify and decode an associate SL-SCH as well as other information.

For example, UE 900 may send the indication 904 during the transmission duration 902 to an RX UE that the UE 900 will extend one or more DRX on-durations. In the case that the UE 900 does indicate that the UE 900 will extend one or more DRX on-durations into transmission duration(s), the UE 900 may monitor SCI during such transmission durations for transmissions from the other UE when the UE 900 is not actively transmitting.

In some examples, the UE 900 may indicate in the indication 904 which transmission duration(s) will be used as an extended DRX on-duration. For example, in the indication 904, which may be carried in SCI-2, MAC-CE, or PC-5 RRC signaling, the UE 900 may use N bits to indicate the following X transmission duration(s) will or will not be used as extended DRX on-duration(s). In some examples, X=N and the N bits can be in the form of a bitmap. In such an example, the first bit may correspond to the first transmission duration after the other UE receives the indication and/or the first DRX on-duration after the other UE receives the indication, the second bit may correspond to the second transmission duration and/or the second DRX on-duration, and so on. A 1 may indicate that a DRX on-duration may be extended into a transmission duration and a 0 may indicate that a DRX on-duration may not be extended into a transmission duration. For example, the indication 904 may include 3 bits: 101. The first bit, 1, may indicate that the on-duration 906 may be extended into the transmission duration 902, in which case the UE 900 may monitor SCI during the transmission duration 902 for transmissions from the other UE when the UE 900 is not actively transmitting. The second bit, 0, may indicate that the DRX on-duration 916 may not be extended into the transmission duration 912, in which case the UE 900 may not monitor SCI during the transmission duration 912 for transmissions from the other UE when the UE 900 is not actively transmitting and therefore, the other UE should not transmit during the transmission duration 912. The third bit, 1, may indicate that the DRX on-duration 926 may be extended into transmission duration 922, in which case the UE 900 may monitor SCI during the transmission duration 922 for transmissions from the other UE when the UE 900 is not actively transmitting.

In some examples, the N bits of the indication 904 may be in the form of a start and length indicator value (SLIV) which may indicate a starting transmission duration index into which a first DRX on-duration is extended and a number of continuous indices, such as indicating a starting transmission duration and a number of consecutive transmission durations into which a number of consecutive DRX on-durations are extended. In some examples, X=2^{N}. For example, for N=2, index=00 corresponds to the following one transmission duration. Index=01 corresponds to the following two transmission durations, and so on.

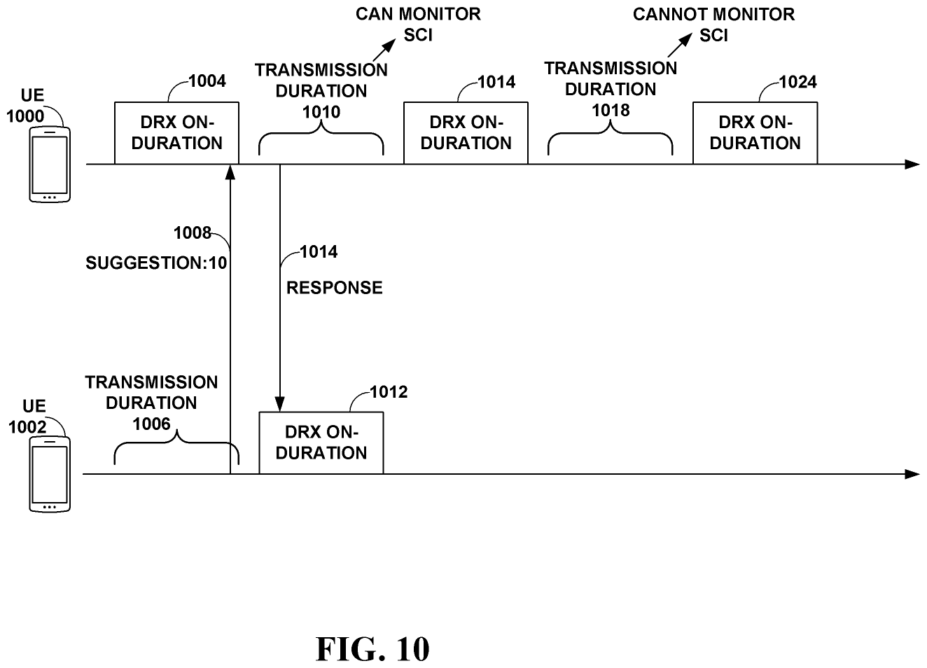

FIG. 10 is a conceptual diagram illustrating example SL communication techniques between two UEs including suggesting an extension of a DRX on-duration according to some aspects of this disclosure. UE 1000 and/or UE 1002 may be examples of other UEs set forth herein, such as scheduled entity/UE 700.

The UE 1002, during a transmission duration 1006 (and a DRX on-duration 1004 of the UE 1000), may send a suggestion 1008 to the UE 1000 that the UE 1000 extend the DRX on-duration for the UE 1002. The Suggestion 1008 may be sent, for example, via SCI-2 or MAC-CE. In such examples, the UE 1000 may determine whether to accept or reject the suggestion 1008 and either accept or reject the suggestion 1008 based on the determination. For example, in the example of FIG. 10, the UE 1000 may determine to accept the suggestion 1008 and may transmit, during the transmission duration 1010 (and during the DRX on-duration 1012), to the UE 1002 an acceptance 1014 that indicates that the UE 1000 accepts the suggestion 1008.

For example, when the UE 1002 determines a resource shortage, the UE 1002 may suggest to the UE 1000 to extend one or more DRX on-durations of the UE 1000 into one or more transmission durations of the UE 1000 so that the UE 1002 may have more transmission opportunities. The UE 1000 may determine whether to accept or reject the suggestion. In some examples, the UE 1002 may suggest to the UE 1000 which transmission duration will be used as an extended DRX on-duration. For example, the suggestion may be carried in SCI-2 or MAC-CE, and use N bits to suggest that the following X transmission duration(s) will be used as extended DRX on-duration(s). Such N bits may be used as discussed above, e.g., as a bitmap, an SLIV, or using X=2^{N}.

For example, the UE 1002 may send the suggestion 1008 as a 2-bit bit map with a value of 10, suggesting that the UE 1000 extend the next DRX on-duration into the next transmission duration and not extend the DRX on-duration that follows the next DRX on-duration. As shown in the example of FIG. 10, the UE 1000 may send the acceptance 1014. As the suggestion 1008 suggested that the UE 1000 extend the next DRX on-duration, the UE 1000 may extend the DRX on-duration 1014 into the transmission duration 1010 and may monitor SCI during the transmission duration 1010 when the UE 1000 is not actively transmitting. As the suggestion 1008 suggested that the UE 1000 not extend the DRX on-duration following the next DRX on-duration, the UE 1000 may not extend the DRX on-duration 1024 into the transmission duration 1018 and may therefore not monitor SCI during the transmission duration 1018.

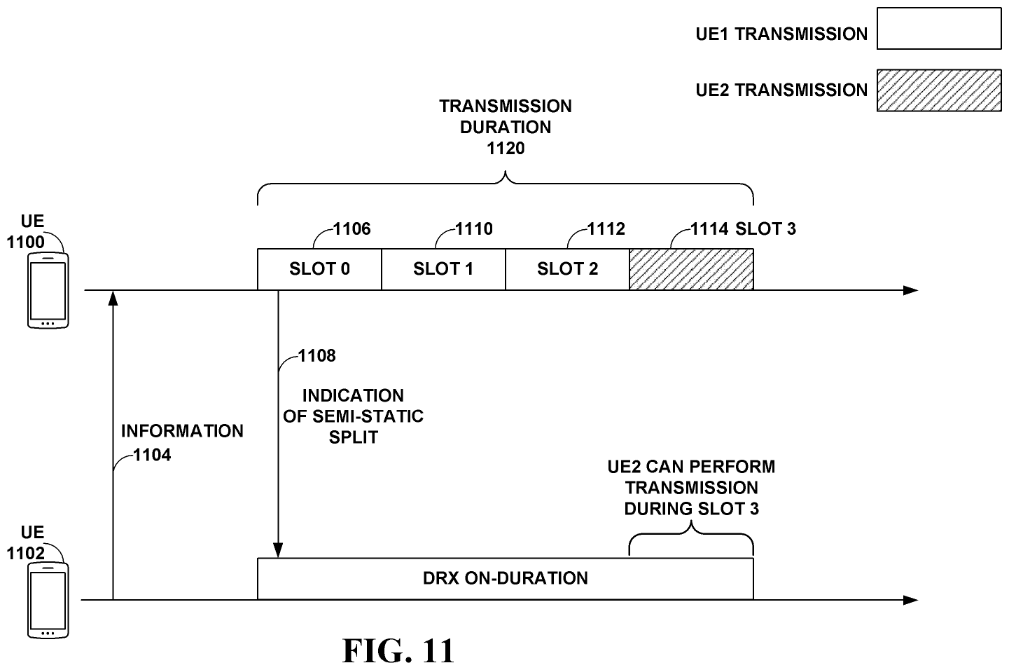

FIG. 11 is a conceptual diagram illustrating an example semi-static split of transmission and reception in a UE transmission duration according to some aspects of this disclosure. UE 1100 and/or UE 1102 may be examples of other UEs set forth herein, such as scheduled entity/UE 700 scheduled entity/UE 700.

In some examples, a UE may facilitate a semi-static split of transmission and reception in the UE's transmission duration. For example, the UE 1102 may report information to the UE 1100 to help the UE 1100 configure a semi-static split of transmission and reception in transmission durations of the UE 1100, such as a transmission duration 1120. A semi-static split may be a split that may be created and exist until the split is explicitly removed or otherwise changed by, for example, UE 1100 and/or UE 1102.

For example, the UE 1102 may determine the LBT success rate by counting the successful LBT attempts made for the UE 1102's transmission in the past t-seconds. In some examples, the UE 1102 may transmit information 1104, which may include the LBT success rate, to the UE 1100, which may be an example of information the UE 1100 may use to determine how to configure the semi-static split of transmission and reception. For example, if the LBT success rate is small (e.g., lower than a threshold, which may be determined by either the UE 1102 or the UE 1100), the UE 1102 may have a resource shortage. In such a case, the UE 1100 may configure one or more slots for the UE 1102 to use to transmit during transmission durations of the UE 1100, such as the transmission duration 1120. If the traffic being transmitted by the UE 1102 is periodic traffic, the UE 1102 may report to the UE 1100 a traffic arrival pattern which may be used by the UE 1100 to determine how to configure the semi-static split of transmission and reception, for example to provide more slots when traffic is heavier and less slots (or no additional slots) when traffic is lighter.

In some examples, the UE 1100 may indicate to the UE 1102 a semi-static split of transmission and reception determined by the UE 1100 via an indication 1108 of the semi-static split by using PC-5 RRC signaling. For example, in the example of FIG. 11, the UE 1100 is committed to not transmit to the UE 1102 in slots split for transmission by the UE 1102, such as slot 3 1114, but is free to transmit in slot 0 1106, slot 1 1110, and slot 2 1112.

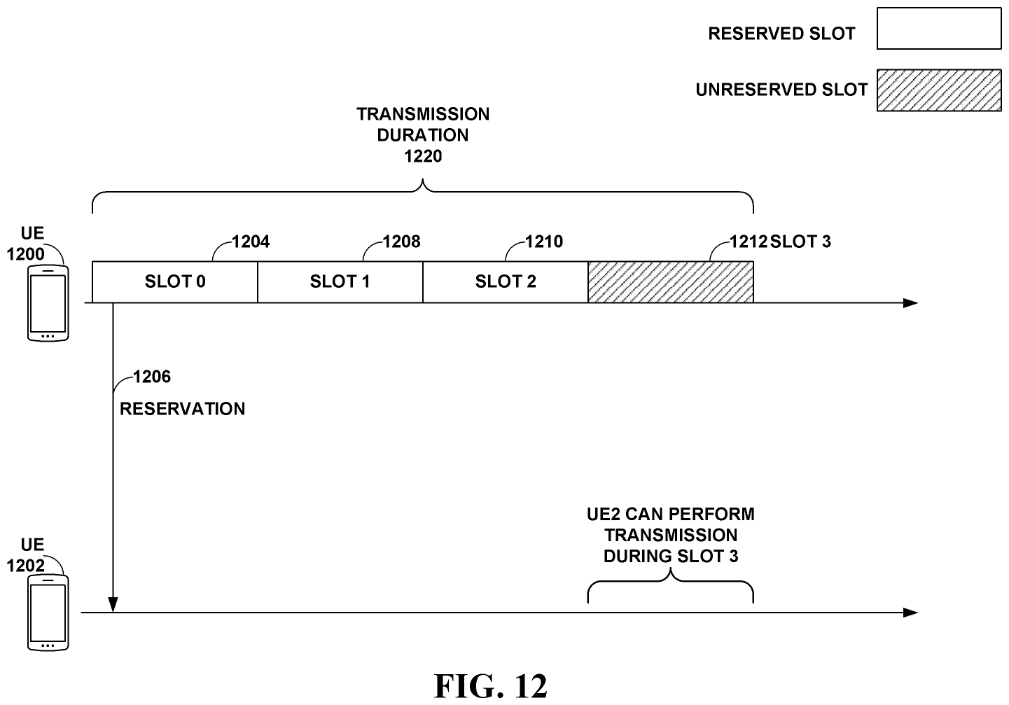

FIG. 12 is a conceptual diagram illustrating an example of reservation of future transmission slots according to some aspects of this disclosure. UE 1200 and/or UE 1202 may be examples of other UEs set forth herein, such as scheduled entity/UE 700.

In some examples, a UE may reserve future transmission slots in the transmission duration of that UE to avoid a collision with transmissions from another UE. For example, the UE 1200 may reserve future transmission slots of the UE 1200 for transmission by the UE 1200 in a transmission duration 1220. The UE 1200 may provide an indication 1206 of any reserved slots in the transmission duration 1220 to the UE 1202 in SCI-2 or MAC-CE, for example in slot 0 1204. The UE 1200 may perform SCI monitoring in the non-reserved slots in the transmission duration 1220. For example, the indication 1206 may indicate that the UE 1200 is reserving slot 0 1204, slot 1 1208, and slot 2 1210. The UE 1202 may transmit during the DRX on-duration of the UE 1202 (during the transmission duration 1220) if the UE 1202 successfully decodes the indication 1206 and determines the non-reserved slots for the UE 1200 (e.g., slot 3 1212). The UE 1202 may transmit to the UE 1200 in any of the non-reserved slots.

For an indication carried in SCI-2 or MAC-CE, the UE 1200 may use N bits in the indication (e.g., the indication 1206) to reserve the future X slots. For example, the N bits can be formed as a bitmap or the N bits can be formed as a time resource indicator value (TRIV). Details of TRIV are known to those of ordinary skill in the art, and may be found in 3GPP specifications for 5G NR, e.g., in technical specification TS 38.214.

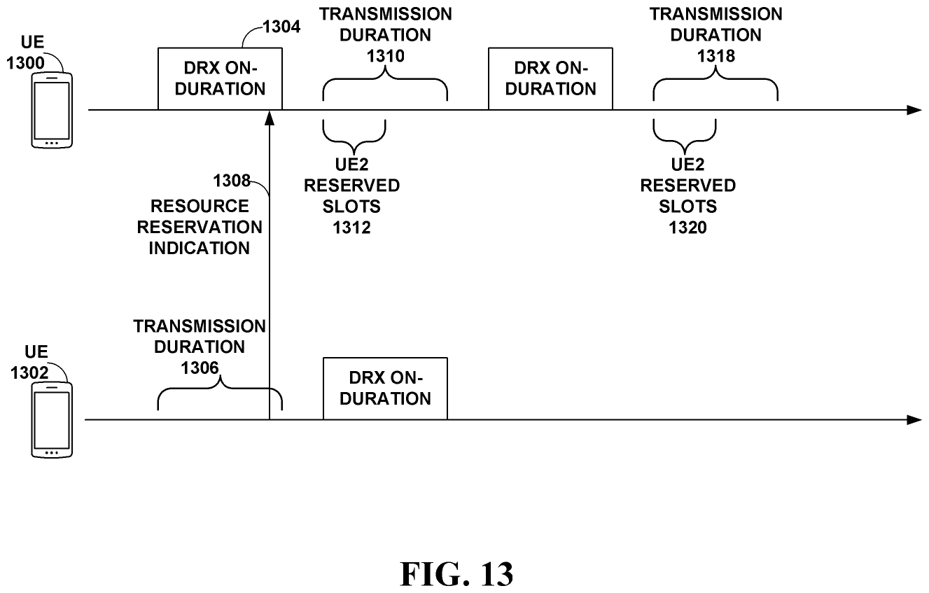

FIG. 13 is a conceptual diagram illustrating an example of the overriding of reserved slots to prioritize high priority traffic according to some aspects of this disclosure. UE 1300 and/or UE 1302 may be examples of other UEs set forth herein, such as scheduled entity/UE 700 scheduled entity/UE 700.

For example, the UE 1302 may prioritize the UE 1302 traffic if the UE 1302 traffic has a higher priority than the UE 1300 traffic or if the traffic of the UE 1302 has a priority higher than a priority threshold. For example, during a transmission duration 1306 (and a DRX on-duration 1304), the UE 1302 may reserve future transmission resources via a resource reservation indication 1308 in transmission duration(s) of the UE 1300 (e.g., a transmission duration 1310 and/or a transmission duration 1318) when the traffic of the UE 1302 has a priority higher than the priority threshold (or higher than the priority of the UE 1300 traffic). The resource reservation indication 1308 may be carried in an SCI-2, an SCI-3 (e.g., a new third stage of SCI), or a MAC-CE. For example, if the resource reservation indication 1308 is carried in SCI-2, traditional SCI-2 may be changed to include a new format to carry the resource reservation indication 1308. If the resource reservation indication 1308 is carried in SCI-3, a 3rd stage SCI may be created to carry the resource reservation indication 1308. If the traffic prioritization is enabled in SCI-2, the UE 1302 may transmit the 3rd stage SCI. Otherwise, the UE 1302 may not transmit the 3rd stage SCI. The resource reservation indication 1308 may include time resources (e.g., TRIV) for up to N slots. The reserved resources may be applied to multiple transmission durations. For example, the UE 1302 may reserve slots 1312 in the transmission duration 1310 and slots 1320 in the transmission duration 1318 for the UE 1302 to transmit to the UE 1300.

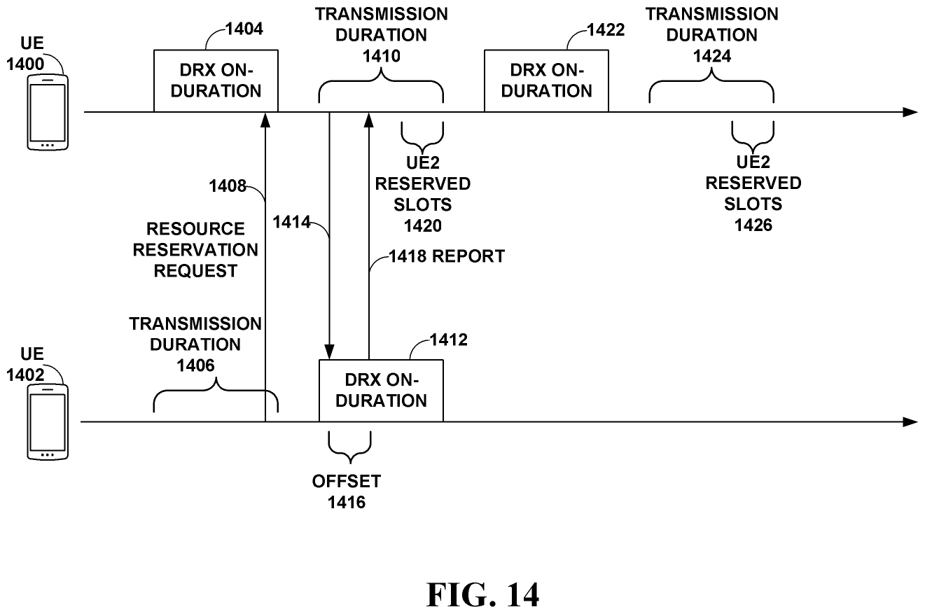

FIG. 14 is a conceptual diagram illustrating an example of negotiating reserved slots based on priority according to some aspects of this disclosure. UE 1400 and/or UE 1402 may be examples of other UEs set forth herein, such as scheduled entity/UE 700 scheduled entity/UE 700.

The UE 1402 may send a resource reservation request 1408 (which may be a resource reservation indication) to the UE 1400 during a transmission duration 1406 (and a DRX on-duration 1404), which may include an indication of the traffic priority of the traffic of the UE 1402. For example, the traffic priority may be indicated using a fixed number of bits, such as 3 bits.

The UE 1400 may determine whether the traffic of the UE 1402 has higher priority than the traffic of the UE 1400. If traffic of the UE 1402 does have a higher priority than traffic of the UE 1400, the UE 1400 may send a request 1414 to trigger traffic prioritization of the traffic of the UE 1402. In such a case, the UE 1402 may determine resources to reserve and may send a report 1418 of the reserved resources to the UE 1400, for example during a DRX on-duration 1412 (and a transmission duration 1410). In the example of FIG. 14, because the UE 1400 has determined that traffic of the UE 1402 has a higher priority than traffic of the UE 1400 and sent the request 1414 to the UE 1402, the UE 1400 may expect the report 1418 in response to the request 1414 and therefore monitor SCI for the report 1418.

The resource reservation request 1408, the request 1414, and/or the report 1418 may be carried in SCI-2, SCI-3, or MAC-CE. For example, if carried in SCI-2, a new SCI-2 format, “SCI 2-D,” may carry the resource reservation request 1408, the request 1414, and/or the report 1418. If carried in SCI-3, a new third stage SCI may carry the resource reservation request 1408, the request 1414, and/or the report 1418. If the traffic prioritization is enabled in SCI-2, the third stage SCI may be transmitted. Otherwise, the third stage SCI may not be transmitted.

The request 1414 from the UE 1400 may include an expected reporting slot index during which the UE 1400 expects to receive the report 1418 so that the UE 1400 may be monitoring SCI during transmission of the report 1418. The expected reporting slot index may take the form of an offset 1416 between the expected reporting slot (e.g., of the report 1418) and the slot that received the request 1414. In order to receive the report 1418 from the UE 1402, the UE 1400 may insert a gap before the expected reporting slot to let the UE 1402 pass the LBT, or the UE 1400 may perform a channel occupancy time (COT) sharing with the UE 1402.

The report 1418 may include TRIV for up to N slots. The reserved resources may be applied to multiple transmission durations. For example, the UE 1402 may reserve slots 1420 in the transmission duration 1410 and slots 1426 in the transmission duration 1424.

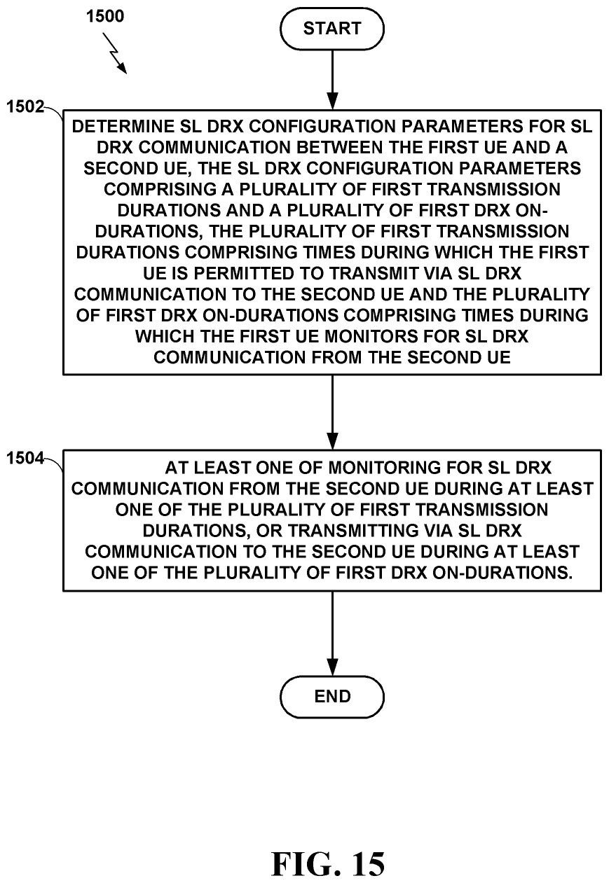

FIG. 15 is a flow diagram illustrating example SL DRX techniques according to one or more aspects of this disclosure. The techniques of FIG. 15 are described with respect to UE 800 and UE 802 of FIG. 8, but may be practiced by any UE described herein.

The UE 800 may determine sidelink (SL) discontinuous reception (DRX) configuration parameters for SL communication between a first UE (e.g., the UE 800) and a second UE (e.g., the UE 802) (1502). The SL DRX configuration parameters may include a plurality of first transmission durations (such as the transmission duration 804) and a plurality of first DRX on-durations (such as the DRX on-duration 812). The plurality of first transmission durations may include times during which the first UE is permitted to transmit via SL communication to the second UE and the plurality of first DRX on-durations may include times during which the first UE monitors for SL communication from the second UE. For example, the UE 800 and the UE 802 may negotiate the SL DRX configuration parameters between themselves. Alternatively, a scheduling entity, such as the scheduling entity 600 may transmit the SL DRX configuration parameters to the UE 800 and/or the UE 802, and the UE 800 may determine the SL DRX configuration parameters from the transmitted SL DRX configuration parameters.

The UE 800 may, at least one of, monitor for SL communication from the second UE during at least one of the plurality of first transmission durations, or transmit via SL communication to the second UE during at least one of the plurality of first DRX on-durations (1504). For example, the UE 800 may monitor SCI for SL communication from the UE 802 during the transmission duration 804. Additionally, or alternatively, the UE 800 may transmit via SL communication to the UE 802 during the DRX on-duration 812.

In some examples, the plurality of first transmission durations correspond to a plurality of second DRX on-durations and the plurality of first DRX on-durations correspond to a plurality of second transmission durations. For example, the transmission duration 804 corresponds in time to the DRX on-duration 810 and the DRX on-duration 812 corresponds in time to the transmission duration 814. In some examples, the plurality of second transmission durations includes times during which the second UE is permitted to transmit via SL communication to the first UE and the plurality of second DRX on-durations include times during which the second UE monitors for SL communication from the first UE.

In some examples, as described above and illustrated in FIG. 9, the UE 900 may transmit an indication (e.g., the indication 904) during one of the plurality of first transmission durations to another UE, the indication being indicative of the UE 900 extending the at least one of the plurality of first DRX on-durations into the at least one of the plurality of first transmission durations. In some examples, transmitting the indication 904 includes transmitting the indication 904 via SCI-2, MAC-CE, or PC-5 RRC signaling. In some examples, the indication 904 includes a bitmap. In some examples, the bitmap includes a plurality of bits, each of the plurality of bits being indicative of whether a respective first DRX on-duration of the plurality of extended first DRX on-durations is extended into a respective first transmission duration of the plurality of first transmission durations.

In some examples, the indication 904 includes an SLIV. In some examples, the SLIV is indicative of a starting first transmission duration into which a first DRX on-duration of the plurality of extended first DRX on-durations is extended and a number of consecutive first transmission durations of the plurality of first transmission durations into which a number of consecutive DRX on-durations of the plurality of first DRX on-durations are extended.

In some examples, the indication 904 includes an index, the index being indicative of a number of consecutive first transmission durations of the plurality of first transmission durations into which a number of consecutive DRX on-durations of the plurality of first DRX on-durations are extended.

In some examples, as described above and illustrated in FIG. 10, the UE 1000 may receive a suggestion (e.g., the suggestion 1008) from the UE 1002, the suggestion indicating that the UE 1000 extend the at least one of the plurality of first DRX on-durations into the at least one of the plurality of first transmission durations. In some examples, the UE 1000 may determine whether to extend the at least one of the plurality of first DRX on-durations into the at least one of the plurality of first transmission durations. In some examples, the UE 1000 may transmit, to the UE 1002, a response (e.g., the response 1014) to the suggestion 1008, the response 1014 being indicative of whether the suggestion 1008 is accepted. In some examples, receiving the suggestion 1008 includes receiving the suggestion 1008 via SCI-2 or MAC-CE. In some examples, the suggestion 1008 includes a bitmap. In some examples, the bitmap includes a plurality of bits, each of the plurality of bits being indicative of whether to extend a respective first DRX on-duration of the plurality of first DRX on-durations into a respective first transmission duration of the plurality of first transmission durations. In some examples, the suggestion 1008 includes an SLIV. In some examples, the SLIV is indicative of a starting transmission duration into which a first DRX on-duration of the plurality of extended first DRX on-durations is extended and a number of consecutive transmission durations of the plurality of first transmission durations into which a number of consecutive DRX on-durations of the plurality of first DRX on-durations are extended. In some examples, the suggestion 1008 includes an index, the index being indicative of a number of consecutive first transmission durations of the plurality of first transmission durations into which a number of consecutive DRX on-durations of the plurality of first DRX on-durations are extended.

In some examples, as described above and illustrated in FIG. 11, the UE 1100 may receive, from the UE 1102, the information 1104 including at least one of LBT success information, or the UE 1102 traffic arrival pattern information. In some examples, the UE 1100 may determine, based on the received information 1104, a semi-static split of transmission and reception for the at least one of the plurality of first DRX on-durations. In some examples, the UE 1100 may transmit, to the UE 1102, an indication 1108 of the semi-static split of transmission and reception for the at least one of the plurality of first DRX on-durations. In some examples, transmitting the indication includes transmitting the indication via PC-5 RRC signaling.

In some examples, as described above and illustrated in FIG. 12, the UE 1200 may reserve one or more future slots in the at least one of the plurality of first transmission durations for transmission by the UE 1202 to the UE 1200. In some examples, the UE 1200 may transmit a reservation 1206 indicative of the one or more future slots to the UE 1202. In some examples, transmitting the reservation 1206 includes transmitting the reservation 1206 via SCI-2 or MAC-CE. In some examples, the reservation 1206 includes a bitmap. In some examples, the bitmap includes a plurality of bits, each of the plurality of bits being indicative of whether a respective future slot is reserved. In some examples, the reservation 1206 includes a TRIV.

In some examples, as described above and illustrated in FIG. 13, the UE 1300 may receive a resource reservation indication (e.g., the resource reservation indication 1308) from the UE 1302, the resource reservation indication 1308 being indicative of a priority of traffic to be transmitted from the UE 1302 to the UE 1300. In some examples, the UE 1300 may reserve one or more slots of the at least one of the plurality of first transmission durations for transmission of the traffic from the UE 1302 to the UE 1300. In some examples, the resource reservation indication 1308 is indicative of the priority of traffic to be transmitted from the UE 1302 to the UE 1300 being higher than a priority threshold. In some examples, receiving the resource reservation indication 1308 includes receiving the resource reservation indication 1308 in an SCI-2. In some examples, receiving the resource reservation indication 1308 includes receiving the resource reservation indication 1308 in an SCI-3. In some examples, receiving the resource reservation indication 1308 includes receiving the resource reservation indication 1308 in a MAC-CE. In some examples, the resource reservation indication 1308 includes a TRIV.

In some examples, as described above and illustrated in FIG. 14, the resource reservation indication may be a resource reservation request 1408. The UE 1400 may determine whether the priority of traffic to be transmitted from the UE 1402 to the UE 1400 is higher than a priority of traffic to be transmitted from the UE 1400 to the UE 1402, for example based on priority information contained in the resource reservation request 1408. Based on the priority of traffic to be transmitted from the UE 1402 to the UE 1400 being higher than the priority of traffic to be transmitted from the UE 1400 to the UE 1402, the UE 1400 may transmit a request 1414 to the UE 1402 to prioritize traffic. In some examples, the UE 1400 may receive, from the UE 1402, a report 1418 of reserved resources, the report 1418 of reserved resources reserving one or more slots (e.g., slots 1420 and/or slots 1426) of the at least one of the plurality of first transmission durations for transmission by the UE 1402 to the UE 1400. In some examples, at least one of the resource reservation request 1408, the request 1414, or the report 1418 of reserved resources is in an SCI-2. In some examples, at least one of the resource reservation request 1408, the request 1414, or the report 1418 of reserved resources is in an SCI-3. In some examples, at least one of the resource reservation request 1408, the request 1414, or the report 1418 of reserved resources is in a MAC-CE. In some examples, the request 1414 includes an offset between an expected reporting slot and a slot of the request 1414. In some examples, the report 1418 of reserved resources includes a TRIV.

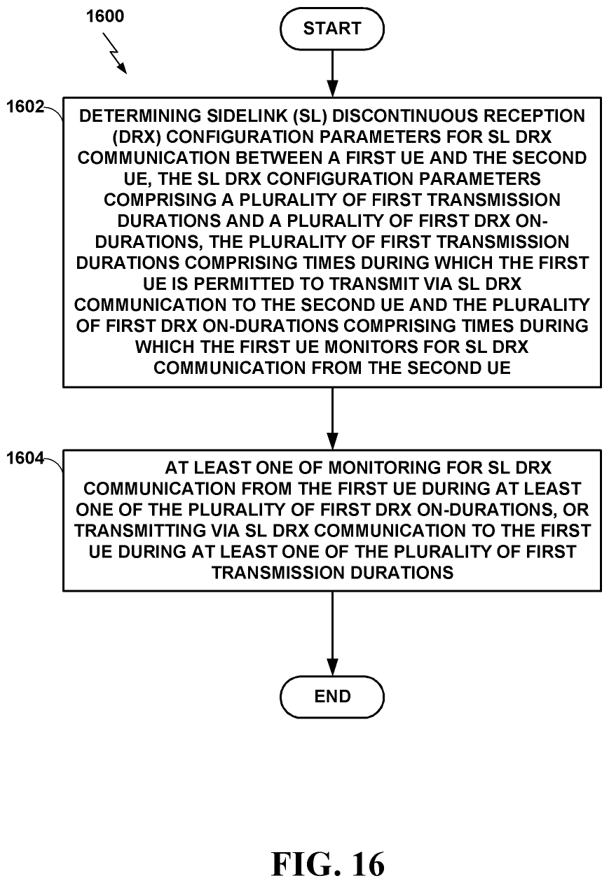

FIG. 16 a flow diagram illustrating additional example SL DRX techniques according to one or more aspects of this disclosure. The techniques of FIG. 16 are described with respect to UE 800 and UE 802 of FIG. 8, but may be practiced by any UE described herein.

The UE 802 may determine SL DRX configuration parameters for SL communication between a first UE and the second UE (1602). The SL DRX configuration parameters may include a plurality of first transmission durations (such as transmission duration 804) and a plurality of first DRX on-durations (such as the DRX on-duration 812). The plurality of first transmission durations may include times during which the first UE is permitted to transmit via SL communication to the second UE and the plurality of first DRX on-durations may include times during which the first UE monitors for SL communication from the second UE. For example, the UE 800 and the UE 802 may negotiate the SL DRX configuration parameters between themselves. Alternatively, a scheduling entity, such as the scheduling entity 600 may transmit the SL DRX configuration parameters to the UE 800 and/or the UE 802, and the UE 800 may determine the SL DRX configuration parameters from the transmitted SL DRX configuration parameters.

The UE 802 may, at least one of, monitor for SL communication from the first UE during at least one of the plurality of first DRX on-durations, or transmit via SL communication to the first UE during at least one of the plurality of first transmission durations (1604). For example, the UE 802 may monitor SCI for SL communication from the UE 800 during the DRX on-duration 812. Additionally, or alternatively, the UE 802 may transmit via SL communication to the UE 800 during transmission duration 804.

In some examples, the plurality of first transmission durations correspond to a plurality of second DRX on-durations and the plurality of first DRX on-durations correspond to a plurality of second transmission durations. For example, the transmission duration 804 corresponds in time to the DRX on duration 810 and the DRX on-duration 812 corresponds in time to the transmission duration 814. In some examples, the plurality of second transmission durations includes times during which the second UE is permitted to transmit via SL communication to the first UE and the plurality of second DRX on-durations include times during which the second UE monitors for SL communication from the first UE.

In some examples, a UE may receive (e.g., from UE 900) an indication (e.g., the indication 904) during one of the plurality of first transmission durations from the UE 900, the indication being indicative of the UE 900 extending the at least one of the plurality of first DRX on-durations into the at least one of the plurality of first transmission durations. In some examples, receiving the indication 904 includes receiving the indication 904 via SCI-2, MAC-CE, or PC-5 RRC signaling. In some examples, the indication 904 includes a bitmap. In some examples, the bitmap includes a plurality of bits, each of the plurality of bits being indicative of whether a respective first DRX on-duration of the plurality of extended first DRX on-durations is extended into a respective first transmission duration of the plurality of first transmission durations. In some examples, the indication 904 includes an SLIV. In some examples, the SLIV is indicative of a starting transmission duration into which a first DRX on-duration of the plurality of extended first DRX on-durations is extended and a number of consecutive transmission durations of the plurality of first transmission durations into which a number of consecutive DRX on-durations of the plurality of first DRX on-durations are extended. In some examples, the indication 904 includes an index, the index being indicative of a number of consecutive first transmission durations of the plurality of first transmission durations into which a number of consecutive DRX on-durations of the plurality of first DRX on-durations are extended.

In some examples, the UE 1002 may transmit a suggestion (e.g., the suggestion 1008) to the UE 1000, the suggestion indicating that the UE 1000 extend the at least one of the plurality of first DRX on-durations into the at least one of the plurality of first transmission durations. In some examples, the UE 1002 may receive, from the UE 1000, a response (e.g., the response 1014) to the suggestion 1008, the response 1014 being indicative of whether the suggestion 1008 is accepted by the UE 1000. In some examples, transmitting the suggestion 1008 includes transmitting the suggestion 1008 via SCI-2 or MAC-CE. In some examples, the suggestion 1008 includes a bitmap. In some examples, the bitmap includes a plurality of bits, each of the plurality of bits being indicative of whether to extend a respective first DRX on-duration of the plurality of first DRX on-durations into a respective first transmission duration of the plurality of first transmission durations. In some examples, the suggestion 1008 includes an SLIV. In some examples, the SLIV is indicative of a starting transmission duration into which a first DRX on-duration of the plurality of extended first DRX on-durations is extended and a number of consecutive transmission durations of the plurality of first transmission durations into which a number of consecutive DRX on-durations of the plurality of first DRX on-durations are extended. In some examples, the suggestion 1008 includes an index, the index being indicative of a number of consecutive first transmission durations of the plurality of first transmission durations into which a number of consecutive DRX on-durations of the plurality of first DRX on-durations are extended.

In some examples, the UE 1102 may transmit, to the UE 1100, the information 1104 including at least one of LBT success information, or the UE 1102 traffic arrival pattern information. In some examples, the UE 1102 may receive, from the UE 1100, the indication 1108 of semi-static split of transmission and reception for the at least one of the plurality of first DRX on-durations. In some examples, receiving the indication 1108 includes receiving the indication 1108 via PC-5 RRC signaling.

In some examples, the UE 1202 may receive, from the UE 1200, a reservation 1206 indicative of one or more future slots in the at least one of the plurality of first transmission durations for transmission by the UE 1202. In some examples, receiving the reservation 1206 includes receiving the reservation 1206 via SCI-2 or MAC-CE. In some examples, the reservation 1206 includes a bitmap. In some examples, the bitmap includes a plurality of bits, each of the plurality of bits being indicative of whether a respective future slot is reserved. In some examples, the reservation 1206 includes a TRIV.

In some examples, the UE 1302 may transmit a resource reservation indication (e.g., the resource reservation indication 1308) to the UE 1300, the resource reservation indication 1308 being indicative of a priority of traffic to be transmitted from the UE 1302 to the UE 1300. In some examples, the resource reservation indication 1308 is indicative of the priority of traffic to be transmitted from the UE 1302 to the UE 1300 being higher than a priority threshold. In some examples, the UE 1302 may determine that the priority of traffic to be transmitted from the UE 1302 to the UE 1300 is higher than the priority threshold. In some examples, transmitting the resource reservation indication 1308 includes transmitting the resource reservation indication 1308 in SCI-2. In some examples, transmitting the resource reservation indication 1308 includes transmitting resource reservation indication 1308 in SCI-3. In some examples, transmitting the resource reservation indication 1308 includes transmitting the resource reservation indication 1308 in MAC-CE. In some examples, the resource reservation indication 1308 includes a TRIV.

In some examples, the resource reservation indication may be a resource reservation request 1408. In some examples, the UE 1402 may receive a request 1414 from the UE 1400 to prioritize traffic, the receiving of the request 1414 being based on the priority of traffic to be transmitted from the UE 1402 to the UE 1400 being higher than the priority of traffic to be transmitted from the UE 1400 to the UE 1402. In some examples, the UE 1402 may transmit, to the UE 1400, a report 1418 of reserved resources, the report 1418 of reserved resources reserving one or more slots of the at least one of the plurality of first transmission durations for transmission by the UE 1402 to the UE 1400. In some examples, at least one of the resource reservation indication, the request, or the report of reserved resources is in SCI-2. In some examples, at least one of the resource reservation indication, the request, or the report of reserved resources is in SCI-3. In some examples, at least one of the resource reservation indication, the request, or the report of reserved resources is in MAC-CE. In some examples, the request 1414 includes an offset between an expected reporting slot and a slot of the request 1414. In some examples, the report 1418 of reserved resources includes a TRIV.

### Further Examples Having a Variety of Features

This disclosure includes the following non-limiting aspects.

Aspect 1. A method of wireless communication at a first user equipment (UE), comprising: determining sidelink (SL) discontinuous reception (DRX) configuration parameters for SL communication between the first UE and a second UE, the SL DRX configuration parameters comprising a plurality of first transmission durations and a plurality of first DRX on-durations, the plurality of first transmission durations comprising times during which the first UE is permitted to transmit via SL communication to the second UE and the plurality of first DRX on-durations comprising times during which the first UE monitors for SL communication from the second UE; and at least one of monitoring for SL communication from the second UE during at least one of the plurality of first transmission durations, or transmitting via SL communication to the second UE during at least one of the plurality of first DRX on-durations.

Aspect 2. The method of aspect 1, wherein the plurality of first transmission durations correspond to a plurality of second DRX on-durations and the plurality of first DRX on-durations correspond to a plurality of second transmission durations, wherein the plurality of second transmission durations comprise times during which the second UE is permitted to transmit via SL communication to the first UE and the plurality of second DRX on-durations comprise times during which the second UE monitors for SL communication from the first UE.

Aspect 3. The method of aspect 1 or aspect 2, further comprising transmitting an indication during one of the plurality of first transmission durations to the second UE, the indication being indicative of the first UE extending the at least one of the plurality of first DRX on-durations into the at least one of the plurality of first transmission durations.

Aspect 4. The method of aspect 3, wherein transmitting the indication comprises transmitting the indication via second stage sidelink control information (SCI-2), media access control control element (MAC-CE), or PC-5 radio resource control (PC-5 RRC) signaling.

Aspect 5. The method of aspect 4, wherein the indication comprises a bitmap comprising a plurality of bits, each of the plurality of bits being indicative of whether a respective first DRX on-duration of the plurality of extended first DRX on-durations is extended into a respective first transmission duration of the plurality of first transmission durations.

Aspect 6. The method of aspect 4, wherein the indication comprises a start and length indicator value (SLIV), the SLIV being indicative of a starting first transmission duration into which a first DRX on-duration of the plurality of extended first DRX on-durations is extended and a number of consecutive first transmission durations of the plurality of first transmission durations into which a number of consecutive DRX on-durations of the plurality of first DRX on-durations are extended.

Aspect 7. The method of aspect 4, wherein the indication comprises an index, the index being indicative of a number of consecutive first transmission durations of the plurality of first transmission durations into which a number of consecutive DRX on-durations of the plurality of first DRX on-durations are extended.

Aspect 8. The method of aspect 1 or aspect 2, further comprising: receiving a suggestion from the second UE, the suggestion indicating that the first UE extend the at least one of the plurality of first DRX on-durations into the at least one of the plurality of first transmission durations; and transmitting, to the second UE, a response to the suggestion, the response being indicative of whether the suggestion is accepted.

Aspect 9. The method of aspect 8, wherein receiving the suggestion comprises receiving the suggestion via second stage sidelink control information (SCI-2) or media access control control element (MAC-CE).

Aspect 10. The method of aspect 8, wherein the suggestion comprises a bitmap comprising a plurality of bits, each of the plurality of bits being indicative of whether to extend a respective first DRX on-duration of the plurality of first DRX on-durations into a respective first transmission duration of the plurality of first transmission durations.

Aspect 11. The method of aspect 8, wherein the suggestion comprises a start and length indicator value (SLIV), the SLIV being indicative of a starting transmission duration into which a first DRX on-duration of the plurality of extended first DRX on-durations is extended and a number of consecutive transmission durations of the plurality of first transmission durations into which a number of consecutive DRX on-durations of the plurality of first DRX on-durations are extended.

Aspect 12. The method of aspect 8, wherein the suggestion comprises an index, the index being indicative of a number of consecutive first transmission durations of the plurality of first transmission durations into which a number of consecutive DRX on-durations of the plurality of first DRX on-durations are extended.

Aspect 13. The method of aspect 1 or aspect 2, further comprising: receiving, from the second UE, information comprising at least one of listen before talk (LBT) success information, or second UE traffic arrival pattern information; and transmitting, to the second UE, an indication of a semi-static split of transmission and reception for the at least one of the plurality of first DRX on-durations.

Aspect 14. The method of aspect 13, wherein δtransmitting the indication comprises transmitting the indication via PC-5 radio resource control (PC-5 RRC) signaling.

Aspect 15. The method of aspect 1 or aspect 2, further comprising: reserving one or more future slots in the at least one of the plurality of first transmission durations for transmission by the second UE to the first UE; and transmitting a reservation indicative of the one or more future slots to the second UE.

Aspect 16. The method of aspect 15, wherein transmitting the reservation comprises transmitting the reservation via second stage sidelink control information (SCI-2) or media access control control element (MAC-CE).

Aspect 17. The method of aspect 16, wherein the reservation comprises a bitmap comprising a plurality of bits, each of the plurality of bits being indicative of whether a respective future slot is reserved.

Aspect 18. The method of aspect 16, wherein the reservation comprises a time resource indicator value (TRIV).

Aspect 19. The method of aspect 1 or aspect 2, further comprising: receiving a resource reservation indication from the second UE, the resource reservation indication being indicative of a priority of traffic to be transmitted from the second UE to the first UE; and reserving one or more slots of the at least one of the plurality of first transmission durations for transmission of the traffic from the second UE to the first UE.

Aspect 20. The method of aspect 19, wherein the resource reservation indication is indicative of the priority of traffic to be transmitted from the second UE to the first UE being higher than a priority threshold.

Aspect 21. The method of aspect 20, wherein receiving the resource reservation indication comprises at least one of receiving the resource reservation indication in second stage sidelink control information (SCI-2), receiving the resource reservation indication in third stage sidelink control information (SCI-3), or receiving the resource reservation indication in media access control control element (MAC-CE).

Aspect 22. The method of aspect 20 or aspect 21, wherein the resource reservation indication comprises a time resource indicator value (TRIV).

Aspect 23. The method of aspect 19, further comprising: determining whether the priority of traffic to be transmitted from the second UE to the first UE is higher than a priority of traffic to be transmitted from the first UE to the second UE; based on the priority of traffic to be transmitted from the second UE to the first UE being higher than the priority of traffic to be transmitted from the first UE to the second UE, transmitting a request to the second UE to prioritize traffic; and receiving, from the second UE, a report of reserved resources, the report of reserved resources reserving one or more slots of the at least one of the plurality of first transmission durations for transmission by the second UE to the first UE.

Aspect 24. The method of aspect 23, wherein at least one of the resource reservation indication, the request, or the report of reserved resources is in at least one of second stage sidelink control information (SCI-2), third stage sidelink control information (SCI-3), or media access control control element (MAC-CE).

Aspect 25. The method of aspect 23 or aspect 24, wherein the request comprises an offset between an expected reporting slot and a slot of the request signal.

Aspect 26. The method of any of aspects 23-25, wherein the report of reserved resources comprises a time resource indicator value (TRIV).

Aspect 27. A method of wireless communication at a second user equipment (UE), comprising: determining sidelink (SL) discontinuous reception (DRX) configuration parameters for SL communication between a first UE and the second UE, the SL DRX configuration parameters comprising a plurality of first transmission durations and a plurality of first DRX on-durations, the plurality of first transmission durations comprising times during which the first UE is permitted to transmit via SL communication to the second UE and the plurality of first DRX on-durations comprising times during which the first UE monitors for SL communication from the second UE; and at least one of monitoring for SL communication from the first UE during at least one of the plurality of first DRX on-durations, or transmitting via SL communication to the first UE during at least one of the plurality of first transmission durations.

Aspect 28. The method of aspect 27, wherein the plurality of first transmission durations correspond to a plurality of second DRX on-durations and the plurality of first DRX on-durations correspond to a plurality of second transmission durations, wherein the plurality of second transmission durations comprising times during which the second UE is permitted to transmit via SL communication to the first UE and the plurality of second DRX on-durations comprising times during which the second UE monitors for SL communication from the first UE.

Aspect 29. The method of aspect 27 or aspect 28, further comprising receiving an indication during one of the plurality of first transmission durations from the first UE, the indication being indicative of the first UE extending the at least one of the plurality of first DRX on-durations into the at least one of the plurality of first transmission durations.

Aspect 30. The method of aspect 29, wherein receiving the indication comprises receiving the indication via second stage sidelink control information (SCI-2), media access control control element (MAC-CE), or PC-5 radio resource control (PC-5 RRC) signaling.

Aspect 31. The method of aspect 30, wherein the indication comprises a bitmap comprising a plurality of bits, each of the plurality of bits being indicative of whether a respective first DRX on-duration of the plurality of extended first DRX on-durations is extended into a respective first transmission duration of the plurality of first transmission durations.

Aspect 32. The method of aspect 30, wherein the indication comprises a start and length indicator value (SLIV), the SLIV being indicative of a starting transmission duration into which a first DRX on-duration of the plurality of extended first DRX on-durations is extended and a number of consecutive transmission durations of the plurality of first transmission durations into which a number of consecutive DRX on-durations of the plurality of first DRX on-durations are extended.

Aspect 33. The method of aspect 30, wherein the indication comprises an index, the index being indicative of a number of consecutive first transmission durations of the plurality of first transmission durations into which a number of consecutive DRX on-durations of the plurality of first DRX on-durations are extended.

Aspect 34. The method of aspect 27 or aspect 28, further comprising: transmitting a suggestion to the first UE, the suggestion indicating that the first UE extend the at least one of the plurality of first DRX on-durations into the at least one of the plurality of first transmission durations; and receiving, from the first UE, a response to the suggestion, the response being indicative of whether the suggestion is accepted by the first UE.

Aspect 35. The method of aspect 34, wherein transmitting the suggestion comprises transmitting the suggestion via second stage sidelink control information (SCI-2) or media access control control element (MAC-CE).

Aspect 36. The method of aspect 34, wherein the suggestion comprises a bitmap comprising a plurality of bits, each of the plurality of bits being indicative of whether to extend a respective first DRX on-duration of the plurality of first DRX on-durations into a respective first transmission duration of the plurality of first transmission durations.

Aspect 37. The method of aspect 34, wherein the suggestion comprises a start and length indicator value (SLIV), the SLIV being indicative of a starting transmission duration into which a first DRX on-duration of the plurality of extended first DRX on-durations is extended and a number of consecutive transmission durations of the plurality of first transmission durations into which a number of consecutive DRX on-durations of the plurality of first DRX on-durations are extended.

Aspect 38. The method of aspect 34, wherein the suggestion comprises an index, the index being indicative of a number of consecutive first transmission durations of the plurality of first transmission durations into which a number of consecutive DRX on-durations of the plurality of first DRX on-durations are extended.

Aspect 39. The method of aspect 27 or aspect 28, further comprising: transmitting, to the first UE, information comprising at least one of listen before talk (LBT) success information, or second UE traffic arrival pattern information; and receiving, from the first UE, an indication of semi-static split of transmission and reception for the at least one of the plurality of first DRX on-durations.

Aspect 40. The method of aspect 39, wherein receiving the indication comprises receiving the indication via PC-5 radio resource control (PC-5 RRC) signaling.

Aspect 41. The method of aspect 27 or aspect 28, further comprising receiving, from the first UE, a reservation indicative of one or more future slots in the at least one of the plurality of first transmission durations for transmission by the second UE.

Aspect 42. The method of aspect 41, wherein receiving the reservation comprises receiving the reservation via second stage sidelink control information (SCI-2) or media access control control element (MAC-CE).

Aspect 43. The method of aspect 42, wherein the reservation comprises a bitmap comprising a plurality of bits, each of the plurality of bits being indicative of whether a respective future slot is reserved.

Aspect 44. The method of aspect 42, wherein the reservation comprises a time resource indicator value (TRIV).

Aspect 45. The method of aspect 27 or aspect 28, further comprising transmitting a resource reservation indication to the first UE, the resource reservation indication being indicative of a priority of traffic to be transmitted from the second UE to the first UE.

Aspect 46. The method of aspect 45, wherein the resource reservation indication is indicative of the priority of traffic to be transmitted from the second UE to the first UE being higher than a priority threshold, the method further comprising determining that the priority of traffic to be transmitted from the second UE to the first UE is higher than the priority threshold.

Aspect 47. The method of aspect 46, wherein transmitting the resource reservation indication comprises at least one of transmitting the resource reservation indication in second stage sidelink control information (SCI-2), transmitting the resource reservation indication in third stage sidelink control information (SCI-3), or transmitting the resource reservation indication in media access control control element (MAC-CE).

Aspect 48. The method of aspect 46 or aspect 47, wherein the resource reservation indication comprises a time resource indicator value (TRIV).

Aspect 49. The method of aspect 45, further comprising: receiving a request from the first UE to prioritize traffic, the receiving of the request being based on the priority of traffic to be transmitted from the second UE to the first UE being higher than the priority of traffic to be transmitted from the first UE to the second UE; and transmitting, to the first UE, a report of reserved resources, the report of reserved resources reserving one or more slots of the at least one of the plurality of first transmission durations for transmission by the second UE to the first UE.

Aspect 50. The method of aspect 49, wherein at least one of the resource reservation indication, the request, or the report of reserved resources is in at least one of second level sidelink control information (SCI-2), third stage sidelink control information (SCI-3), or media access control control element (MAC-CE).

Aspect 51. The method of aspect 49 or aspect 50, wherein the request comprises an offset between an expected reporting slot and a slot of the request signal.

Aspect 52. A device for wireless communication by a first user equipment (UE), comprising: memory having executable instructions stored thereon; and one or more processors configured to execute the executable instructions to cause the device to: determine sidelink (SL) discontinuous reception (DRX) configuration parameters for SL communication between the first UE and a second UE, the SL DRX configuration parameters comprising a plurality of first transmission durations and a plurality of first DRX on-durations, the plurality of first transmission durations comprising times during which the first UE is permitted to transmit via SL communication to the second UE and the plurality of first DRX on-durations comprising times during which the first UE monitors for SL communication from the second UE; and at least one of monitor for SL communication from the second UE during at least one of the plurality of first transmission durations, or transmit via SL communication to the second UE during at least one of the plurality of first DRX on-durations.

Aspect 53. The device of aspect 52, wherein the one or more processors are further configured to transmit an indication during one of the plurality of first transmission durations to the second UE, the indication being indicative of the first UE extending the at least one of the plurality of first DRX on-durations into the at least one of the plurality of first transmission durations.

Aspect 54. The device of aspect 52, wherein the one or more processors are further configured to: receive a suggestion from the second UE, the suggestion indicating that the first UE extend the at least one of the plurality of first DRX on-durations into the at least one of the plurality of first transmission durations; and transmit, to the second UE, a response to the suggestion, the response being indicative of whether the suggestion is accepted.

Aspect 55. The device of aspect 52, wherein the one or more processors are further configured to: receive, from the second UE, information comprising at least one of listen before talk (LBT) success information, or second UE traffic arrival pattern information; and transmit, to the second UE, an indication of a semi-static split of transmission and reception for the at least one of the plurality of first DRX on-durations.

Aspect 56. The device of aspect 52, wherein the one or more processors are further configured to: reserve one or more future slots in the at least one of the plurality of first transmission durations for transmission by the second UE to the first UE; and transmit a reservation indicative of the one or more future slots to the second UE.

Aspect 57. The device of aspect 52, wherein the one or more processors are further configured to: receive a resource reservation indication from the second UE, the resource reservation indication being indicative of a priority of traffic to be transmitted from the second UE to the first UE; and reserve one or more slots of the at least one of the plurality of first transmission durations for transmission of the traffic from the second UE to the first UE.

Aspect 58. A device for wireless communication by a second user equipment (UE), comprising: memory having executable instructions stored thereon; and one or more processors configured to execute the executable instructions to cause the device to: determine sidelink (SL) discontinuous reception (DRX) configuration parameters for SL communication between a first UE and the second UE, the SL DRX configuration parameters comprising a plurality of first transmission durations and a plurality of first DRX on-durations, the plurality of first transmission durations comprising times during which the first UE is permitted to transmit via SL communication to the second UE and the plurality of first DRX on-durations comprising times during which the first UE monitors for SL communication from the second UE; and at least one of monitor for SL communication from the first UE during at least one of the plurality of first DRX on-durations, or transmit via SL communication to the first UE during at least one of the plurality of first transmission durations.

Aspect 59. The device of aspect 58, wherein the one or more processors are further configured to receive an indication during one of the plurality of first transmission durations from the first UE, the indication being indicative of the first UE extending the at least one of the plurality of first DRX on-durations into the at least one of the plurality of first transmission durations.

Aspect 60. The device of aspect 58, wherein the one or more processors are further configured to: transmit a suggestion to the first UE, the suggestion indicating that the first UE extend the at least one of the plurality of first DRX on-durations into the at least one of the plurality of first transmission durations; and receive, from the first UE, a response to the suggestion, the response being indicative of whether the suggestion is accepted by the first UE.

Aspect 61. The device of aspect 58, wherein the one or more processors are further configured to: transmit, to the first UE, information comprising at least one of listen before talk (LBT) success information, or second UE traffic arrival pattern information; and receive, from the first UE, an indication of semi-static split of transmission and reception for the at least one of the plurality of first DRX on-durations.

Aspect 62. The device of aspect 58, wherein the one or more processors are further configured to receive, from the first UE, a reservation indicative of one or more future slots in the at least one of the plurality of first transmission durations for transmission by the second UE.

Aspect 63. The device of aspect 58, wherein the one or more processors are further configured to transmit a resource reservation indication to the first UE, the resource reservation indication being indicative of a priority of traffic to be transmitted from the second UE to the first UE.

This disclosure presents several aspects of a wireless communication network with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

The present disclosure uses the word “exemplary” to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The present disclosure uses the terms “coupled” and/or “communicatively coupled” to refer to a direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The present disclosure uses the terms “circuit” and “circuitry” broadly, to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, features and/or functions illustrated in FIGS. 1-16 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-16 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

Applicant provides this description to enable any person skilled in the art to practice the various aspects described herein. Those skilled in the art will readily recognize various modifications to these aspects, and may apply the generic principles defined herein to other aspects. Applicant does not intend the claims to be limited to the aspects shown herein, but to be accorded the full scope consistent with the language of the claims, wherein reference to an element in the singular is not intended to mean “one and only one” unless specifically so stated, but rather “one or more.” Unless specifically stated otherwise, the present disclosure uses the term “some” to refer to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

1. A method of wireless communication at a first user equipment (UE), comprising:
determining sidelink (SL) discontinuous reception (DRX) configuration parameters for SL communication between the first UE and a second UE, the SL DRX configuration parameters comprising a plurality of first transmission durations and a plurality of first DRX on-durations, the plurality of first transmission durations comprising times during which the first UE is permitted to transmit via SL communication to the second UE and the plurality of first DRX on-durations comprising times during which the first UE monitors for SL communication from the second UE; and
at least one of monitoring for SL communication from the second UE during at least one of the plurality of first transmission durations, or transmitting via SL communication to the second UE during at least one of the plurality of first DRX on-durations.

2. The method of claim 1, wherein the plurality of first transmission durations correspond to a plurality of second DRX on-durations and the plurality of first DRX on-durations correspond to a plurality of second transmission durations, wherein the plurality of second transmission durations comprise times during which the second UE is permitted to transmit via SL communication to the first UE and the plurality of second DRX on-durations comprise times during which the second UE monitors for SL communication from the first UE.

3. The method of claim 1, further comprising transmitting an indication during one of the plurality of first transmission durations to the second UE, the indication being indicative of the first UE extending the at least one of the plurality of first DRX on-durations into the at least one of the plurality of first transmission durations.

4. The method of claim 3, wherein transmitting the indication comprises transmitting the indication via second stage sidelink control information (SCI-2), media access control control element (MAC-CE), or PC-5 radio resource control (PC-5 RRC) signaling.

5. The method of claim 4, wherein the indication comprises a bitmap comprising a plurality of bits, each of the plurality of bits being indicative of whether a respective first DRX on-duration of the plurality of extended first DRX on-durations is extended into a respective first transmission duration of the plurality of first transmission durations.

6. The method of claim 4, wherein the indication comprises a start and length indicator value (SLIV), the SLIV being indicative of a starting first transmission duration into which a first DRX on-duration of the plurality of extended first DRX on-durations is extended and a number of consecutive first transmission durations of the plurality of first transmission durations into which a number of consecutive DRX on-durations of the plurality of first DRX on-durations are extended.

7. The method of claim 4, wherein the indication comprises an index, the index being indicative of a number of consecutive first transmission durations of the plurality of first transmission durations into which a number of consecutive DRX on-durations of the plurality of first DRX on-durations are extended.

8. The method of claim 1, further comprising:
receiving a suggestion from the second UE, the suggestion indicating that the first UE extend the at least one of the plurality of first DRX on-durations into the at least one of the plurality of first transmission durations; and
transmitting, to the second UE, a response to the suggestion, the response being indicative of whether the suggestion is accepted.

9. The method of claim 1, further comprising:
receiving, from the second UE, information comprising at least one of listen before talk (LBT) success information, or second UE traffic arrival pattern information; and
transmitting, to the second UE, an indication of a semi-static split of transmission and reception for the at least one of the plurality of first DRX on-durations.

10. The method of claim 1, further comprising:
reserving one or more future slots in the at least one of the plurality of first transmission durations for transmission by the second UE to the first UE; and
transmitting a reservation indicative of the one or more future slots to the second UE.

11. The method of claim 1, further comprising:
receiving a resource reservation indication from the second UE, the resource reservation indication being indicative of a priority of traffic to be transmitted from the second UE to the first UE; and
reserving one or more slots of the at least one of the plurality of first transmission durations for transmission of the traffic from the second UE to the first UE.

12. A method of wireless communication at a second user equipment (UE), comprising:
determining sidelink (SL) discontinuous reception (DRX) configuration parameters for SL communication between a first UE and the second UE, the SL DRX configuration parameters comprising a plurality of first transmission durations and a plurality of first DRX on-durations, the plurality of first transmission durations comprising times during which the first UE is permitted to transmit via SL communication to the second UE and the plurality of first DRX on-durations comprising times during which the first UE monitors for SL communication from the second UE; and
at least one of monitoring for SL communication from the first UE during at least one of the plurality of first DRX on-durations, or transmitting via SL communication to the first UE during at least one of the plurality of first transmission durations.

13. The method of claim 12, wherein the plurality of first transmission durations correspond to a plurality of second DRX on-durations and the plurality of first DRX on-durations correspond to a plurality of second transmission durations, wherein the plurality of second transmission durations comprising times during which the second UE is permitted to transmit via SL communication to the first UE and the plurality of second DRX on-durations comprising times during which the second UE monitors for SL communication from the first UE.

14-16. (canceled)

17. The method of claim 12, further comprising receiving, from the first UE, a reservation indicative of one or more future slots in the at least one of the plurality of first transmission durations for transmission by the second UE.

18. The method of claim 12, further comprising transmitting a resource reservation indication to the first UE, the resource reservation indication being indicative of a priority of traffic to be transmitted from the second UE to the first UE.

19. A device for wireless communication by a first user equipment (UE), comprising:
memory having executable instructions stored thereon; and
one or more processors configured to execute the executable instructions to cause the device to:
determine sidelink (SL) discontinuous reception (DRX) configuration parameters for SL communication between the first UE and a second UE, the SL DRX configuration parameters comprising a plurality of first transmission durations and a plurality of first DRX on-durations, the plurality of first transmission durations comprising times during which the first UE is permitted to transmit via SL communication to the second UE and the plurality of first DRX on-durations comprising times during which the first UE monitors for SL communication from the second UE; and
at least one of monitor for SL communication from the second UE during at least one of the plurality of first transmission durations, or transmit via SL communication to the second UE during at least one of the plurality of first DRX on-durations.

20. The device of claim 19, wherein the one or more processors are further configured to transmit an indication during one of the plurality of first transmission durations to the second UE, the indication being indicative of the first UE extending the at least one of the plurality of first DRX on-durations into the at least one of the plurality of first transmission durations.

21. The device of claim 19, wherein the one or more processors are further configured to:
receive a suggestion from the second UE, the suggestion indicating that the first UE extend the at least one of the plurality of first DRX on-durations into the at least one of the plurality of first transmission durations; and
transmit, to the second UE, a response to the suggestion, the response being indicative of whether the suggestion is accepted.

22. The device of claim 19, wherein the one or more processors are further configured to:
receive, from the second UE, information comprising at least one of listen before talk (LBT) success information, or second UE traffic arrival pattern information; and
transmit, to the second UE, an indication of a semi-static split of transmission and reception for the at least one of the plurality of first DRX on-durations.

23. (canceled)

24. The device of claim 19, wherein the one or more processors are further configured to:
receive a resource reservation indication from the second UE, the resource reservation indication being indicative of a priority of traffic to be transmitted from the second UE to the first UE; and
reserve one or more slots of the at least one of the plurality of first transmission durations for transmission of the traffic from the second UE to the first UE.

25-30. (canceled)
